(19) United States
(12) Patent Application Publication
(10) Pub. No.: US 2025/0207974 A1
(43) Pub. Date: Jun. 26, 2025

(54) Spectroscopic Mapping System

(71) Applicant: Board of Trustees of Michigan State University, East Lansing, MI (US)

(72) Inventor: Elad HAREL, Okemos, MI (US)

(73) Assignee: Board of Trustees of Michigan State University, East Lansing, MI (US)

(21) Appl. No.: 18/985,371

(22) Filed: Dec. 18, 2024

Related U.S. Application Data
(60) Provisional application No. 63/613,175, filed on Dec. 21, 2023.

(51) Int. Cl. G01J 3/28; G01J 3/44; G01N 21/65

(52) U.S. Cl. CPC G01J 3/2823; G01J 3/44; G01N 21/65; G01N 2201/06113

(57) ABSTRACT

A spectroscopic mapping system and method are provided. In a further aspect, a system includes at least one laser, a high speed camera, a fast delay scanning voice coil for imaging, and a programmable controller configured to synchronize the laser(s), camera and voice coil. Another aspect employs a tracer laser beam or pulse, and a pump-probe laser beam or pulse, the pump emission exciting all frequencies in a sample while the probe emission (via a voice coil) vibrates the sample at different points in time. Yet another aspect uses parallel rapid imaging with spectroscopic mapping to conduct ultrafast coherent imaging. In still another aspect, the present system and method include machine learning software instructions to predict chemical properties based on their chemical compositions, using optical spectroscopic data.

### CROSS-REFERENCE TO RELATED APPLICATION

This application claims priority to U.S. provisional patent application Ser. No. 63/613,175, filed on Dec. 21, 2023, which is incorporated by reference herein.

### GOVERNMENT SUPPORT

This invention was made with government support under N00014-20-1-2111 awarded by the U.S. Office of Naval Research, and under HDTRA1-21-1-0026 awarded by the U.S. Defense Threat Reduction Agency. The government has certain rights in the invention.

### BACKGROUND AND SUMMARY

The present application generally pertains to microscopy and more particularly to a spectroscopic mapping system and method of using same.

Many traditional spectroscopic imaging techniques focus on either: (a) vibrational states such as stimulated Raman scattering spectroscopy (“SRS”), coherent anti-stokes Raman scattering spectroscopy (“CARS”) and two-dimensional infrared spectroscopy (“2DIR”), or (b) population decay dynamics, such as two-dimensional electronic spectroscopy (“2DES”), time-resolved fluorescence microscopy (“TRF”), transient-absorption spectroscopy (“TAS”), pump-probe holographic microscopy and structured pump-probe microscopy (“SPPM”). Conventional techniques capable of measuring both electronic and vibrational properties, however, often face significant challenges due to slow acquisition speeds. For example, coherent pump-probe microscopy, captures both electronic and vibrational dynamics, but typically relies on point-by-point scanning methods that significantly extend acquisition time. This prolonged exposure increases the risk of photodamage to the specimen and limits the observation of short-lived phenomena such as phase transitions and non-repeatable processes. Additionally, extended scanning may lead to loss of spatial correlation due to sample drift or fluctuations, compromising the accuracy of correlation mapping. These limitations hinder the ability to fully capture the complexity of spatially dependent material properties, particularly in systems that undergo dynamical changes at short length scales where high spatial and temporal resolution is needed.

Coupling between electronic and vibrational degrees of freedom in solids and heterogeneous materials is desirable. But, due to the vastly different energy scales involved, measuring and correlating electronic and vibrational properties has been difficult with conventional devices. While in principle, ultrafast laser pulses with sufficiently bandwidth generate excited-state population and vibrational coherence signatures, the traditional need to measure the signal point-by-point across the sample results in relatively slow acquisition, has led to an increased risk of sample photodamage and rendering the measurements highly susceptible to undesirable noise. In addition, point-by-point scanning with conventional 2DES and impulsive stimulated Raman scattering spectroscopy (“ISRS”) increases vulnerabilities to external disturbances, potentially degrading the signal-to-noise ratio (“SNR”) and compromising measurement accuracy.

One such traditional point-by-point microscopy device is disclosed in U.S. Patent Publication No. 2024/0337627 entitled “System and Method for Fast Microscopy” which published to Mehendale, et al., on Oct. 10, 2024, and is incorporated by reference herein. This device has a pump laser, a probe laser, a voice coil and a camera, for use in ensuring proper alignment and overlay during semiconductor fabrication by localized mapping of buried structures using images acquired by the camera. Moreover, a high-resolution optical microscope is disclosed in PCT patent publication no. WO/2024/129857 entitled “Optical Imaging Apparatus,” published to common inventor Elad Harel on Jun. 20, 2024, which is incorporated by reference herein.

In accordance with the present invention, a spectroscopic mapping system and method are provided. In a further aspect, a system includes at least one laser, a high speed camera, a fast delay scanning voice coil for imaging, and a programmable controller configured to synchronize the laser(s), camera and voice coil. Another aspect employs a tracer laser beam or pulse, and a pump-probe laser beam or pulse, the pump emission exciting all frequencies in a sample while the probe emission is delayed in line (via a voice coil), capturing different instances in time of the sample vibration or excited-state relaxation.

Furthermore, the tracer light is used to detect the spatial position of the voice coil at the moment the camera captures the image, in an exemplary configuration. Yet another aspect uses parallel rapid imaging with spectroscopic mapping to conduct ultrafast coherent imaging. In still another aspect, the present system and method include machine learning software instructions to predict chemical properties based on their chemical compositions, using optical spectroscopic data.

The present system and method advantageously provide very fast and wide field of view (“FOV”) imaging and analysis of the sample while generating or capturing at least 1.6 million spectra data points per second of the sample (with each spectra containing about 200 channels or points), and more preferably generating or capturing at least 350 million spectral data points per second, thereby obtaining significantly improved imaging resolution as compared to slow raster scanning methods. So, both very fast dynamics and much slower dynamics are beneficially captured. As another example, if a material specimen is undergoing some sort of stress but that stress occurs slowly, then the present system captures these hyperspectral maps so the inter-and intramolecular interaction changes can be watched or monitored in real-time.

The present high-speed imaging and resolution beneficially allows real-time analysis and mapping of the sample in real-time, such as a living cell as it is dividing, pharmaceutical composition interaction with a living cell, material undergoing stress, observing crystal growth, and the like. The present system and method detect contrast relaxation rates after a sample material responds to photonic stimulation, preferably simultaneously with many different frequencies emitted by the pump-probe laser. The present system is not limited directly by the frequencies emitted by the pump or probe. Instead, the system measures difference frequencies and is actually limited by the bandwidth of the pulses, but not on their absolute frequency. For example, if a pulse at 800 nm (near-infrared) is used, but because this pulse is very short in time, it has a large bandwidth (˜100 nm, so it spans 750-850 nm, for example). The bandwidth at this frequency corresponds to 50 THz which means signals from ˜0.1-50 THz are measured. Accordingly, the present system and method provide access to a full vibrational range of frequencies at the same time, including local molecular bonds and intermolecular interactions, which allows the controller to automatically distinguish between different material characteristics and/or different intermolecular interactions in the sample. Additional features and benefits of the present system and method will become apparent from the following description and appended claims in combination with the associated figures.

### BRIEF DESCRIPTION OF THE DRAWINGS

FIGS. 1 and 2 are diagrammatic views showing the present spectroscopic mapping apparatus;

FIG. 3 is a graph showing a timing diagram of synchronized components of the present apparatus;

FIGS. 4 and 5 are graphs showing a typical image sequence, where each pixel encodes local electronic and vibrational states information, of the present apparatus;

FIG. 6 is a series of graphs showing energy level diagrams depicting three examples of pump-induced dynamics: excited state population, excited state coherence and ground state coherence, followed by probe detection after a delay time Δt;

FIG. 7 is a scan and graph showing in a bright-field image of a mechanically exfoliated WSe₂ flake, a mixed morphology of bulk and few-layer regions; and in the graph, an AFM trace along the dashed line;

FIG. 8 is a graph showing normalized transmittance of a single pixel from PRISM measurements in a layer and bulk region;

FIG. 9 is a scan and graph showing isolated oscillatory components from FIG. 8, where a zoomed-in 700 fs region highlights the sinusoidal nature of the oscillations, and the image, after subtracting the exponential decay at the dot, reveals intensity variations across an entire flake;

FIG. 10 is a graph showing a spectral comparison between the layer and bulk region;

FIG. 11 depicts scans showing an intensity map at two different decay time constants;

FIG. 12 depicts scans showing a hyperspectral map at four different frequencies, highlighting heterogeneities caused by variations in layer number;

FIG. 13 depicts scans showing time constant and hyperspectral maps at highest acquisition speed of 50 ms;

FIGS. 14-16 show PL scanned images of MAPbBr₃ and MAPb(BrₓI₁₋ₓ)₃ crystals, captured at the start of each synchronized PRISM scan;

FIG. 17 is a graph showing the PL spectra of the two types of crystals, wherein for MAPbBr₃, the PL peak is centered around 540 nm, while partial substitution of bromide ions with iodide leads to a redshift in the bandgap, resulting in a broader PL wavelength distribution in the 600-800 nm range;

FIG. 18 is a graph showing a normalized time-resolved transmittance change of a single pixel located at the center of the crystal from the PRISM measurements, wherein replacing part of the bromide atoms with iodide alters the time-resolved response;

FIG. 19 is a graph showing isolated oscillatory components, which highlights distinct vibrational dynamics between two types of perovskites, with these differences further emphasized in the spectra shown in FIG. 20;

FIG. 20 is a graph showing a spectrum comparison between the two types of crystals;

FIG. 21 depicts scans showing decay time constant maps for MAPbBr₃ (top) and MAPb(BrₓI₁₋ₓ)₃ (bottom);

FIG. 22 depicts scans showing hyperspectral maps highlighting crystal heterogeneity;

FIG. 23 is a scan showing segmentation of different regions based on bright-field transmittance, wherein a red region primarily corresponds to few-layer areas and edges, while blue and green regions represent bulk areas;

FIG. 24 shows a correlation scatter plot for a low-frequency vibrational region;

FIG. 25 shows a correlation scatter plot for a high-frequency vibrational region;

FIG. 26 is a three-dimensional graph showing a principal component analysis based on seven parameters: two decay components (˜1.2 ps and >10 ps), four spectral peaks (0.2, 0.6, 7.4, and 7.5 THz), and bright-field transmittance;

FIG. 27 is a scan showing spatial mapping of regions corresponding to the clusters identified in FIG. 26;

FIG. 28 is a graph showing a calibration curve between the lab time (camera frame time) and molecular time (stage position);

FIG. 29 is a graph showing c-DAQ output pulses for synchronization of the PRISM hardware;

FIG. 30 depicts graphs showing a comparison between a WSe₂ single-pixel time trace without SVD (top) and with SVD (bottom);

FIG. 31 is a graph showing time traces at single spatial points compared with denoised curves at different scaling factors;

FIG. 32 is a graph showing corresponding spectra before and after denoising;

FIG. 33 is a graph showing a residual noise signal;

FIG. 34 is a graph showing a standard deviation of noise, identifying the optimal scaling parameter;

FIG. 35 is a diagram showing logic flow of a field-programmable gate array of the present apparatus;

FIGS. 36A and 36B are diagrams showing detailed software logic of the present apparatus;

FIG. 37 is a diagrammatic view showing chemical space-property predictor model development workflow used with the present apparatus, where the left pane depicts high-throughput approaches for the synthesis of an array of perovskite single crystals, the middle pane depicts a spectroscopic analysis of the perovskites, and data accumulation for artificial neural networks model, and the right pane depicts the data flowing to ANN to develop a desired model;

FIG. 37 is a diagrammatic view showing single crystals of perovskite materials under a high-resolution optical microscope, where at the right side, single crystals of the perovskites in the selected region crystalized add 1:1 (v/v) GBL solvent to mixed precursor solutions. The numbers at the three outer lines represent the chemical composition of the respective halide in perovskites. The images use a coordinate system of a ternary plot;

FIG. 39 is a diagrammatic view showing UV-visible spectra and their first derivative curve of perovskite materials. The UV-visible spectra are represented by gray color and the first derivative curves are represented by a colormap with 50% appearance. The color of the first derivative curve was selected from the colormap based on a wavelength of peak maxima. The spectra are positioned following the coordinate system of the ternary plot;

FIG. 40 is a diagrammatic view showing photoluminescence of perovskite single crystals. The excitation source is a 343 nm laser. The images are represented following the coordinate system of the ternary plot;

FIG. 41 is a diagrammatic view showing THz Raman spectra of perovskite single crystals that are represented by gray color and the deconvoluted peaks are represented by the colormap with 50% appearance. The color of the peaks was selected from the colormap based on the wave number of peak maxima. The spectra are positioned following the coordinate system of the ternary plot. The Raman laser source is a 785 nm laser; and

FIGS. 42-45 are graphs showing statistical results (regression coefficient and mean squared error) of algorithms using different data sets.

### DETAILED DESCRIPTION

Inter-and intra-molecular interactions in solids dictate a variety of physical and chemical properties, ranging from structural characteristics and carrier transports to reaction pathways and the emergence of topological states. In heterogeneous materials, compositional changes and local nanoscale environments tune these properties spatially. Correlating molecular interactions with structural and compositional features necessitates statistical analysis across numerous measurements to establish direct causal relationships. Accordingly, a preferred embodiment of the present apparatus includes a wide-field pump-probe method for massively parallel mapping of local/delocalized vibrational motion and carrier dynamics, with femtosecond temporal and sub-diffraction spatial resolution.

The present approach measures up to 1.6 million wideband spectra per second, by way of nonlimiting example, spanning from sub-THz to tens of THz, and creates population decay maps capturing picosecond dynamics. It is noteworthy that these spectra per second numbers can be increased if alternate higher resolution cameras are used, and if shorter pulse durations are emitted. Thus, it is expected that with this higher resolution and shorter pulse arrangement, more than 10 million spectra per second can be obtained and it is possible to scan in the range from 10 GHz to 100 or more THz.

The present approach is demonstrated on 2D materials, including few-layer WSe₂ and monolayer WSe₂, MoS₂ heterostructures, by way of nonlimiting example, allowing the observation of enhanced contrast in vibrational modes and exciton dynamics due to varying local intermolecular interactions. This beneficially allows the observation of dynamic processes in highly heterogeneous systems ranging from quantum materials to live cells, with data richness suitable for machine learning and advanced statistical analysis to directly correlate among structure, function, and dynamics.

The preferred embodiment of the present spectroscopic mapping system employs a Parallel Rapid Imaging with Spectroscopic Mapping (“PRISM”) method, which includes a novel wide-field, ultrafast coherent imaging technique that enables parallel mapping of vibrational motions and excited-state dynamics with femtosecond precision and sub-diffraction spatial resolution across nearly 100,000 pixels. For example, PRISM captures over 1.5 million dynamic traces and wideband spectra (5-600 cm⁻¹) per second, with full, three-dimensional spatial/spectral data collection in as fast as 50 milliseconds.

Furthermore, PRISM provides high-resolution mapping of the heterogeneity of electronic and vibrational states over a large field of view. This allows it to disentangle local effects caused by sample morphology through correlation analysis, which is difficult to observe with conventional methods. The correlative analysis enables the identification of hidden spatial domains whereby structural features control electronic and vibrational dynamics. This capability makes PRISM well-suited for diverse applications, including material screening based on mechanical and chemical composition, defect analysis, real-time bioimaging, reaction pathway monitoring, and, more generally, tracking of irreversible events that occur on the millisecond to second time scale. Additionally, the extensive datasets (over a few GB per measurement) generated by PRISM may be used in advanced statistical analysis, including machine learning methods to aid in uncovering otherwise hidden correlations and patterns in complex material properties and structures, which offers new insights and optimizations for material design and discovery. PRISM's ability to measure mechanical and chemical properties at video frame rates promises transformative applications in real-time medical imaging, nanomaterial research, reaction pathway analysis, and live cell monitoring.

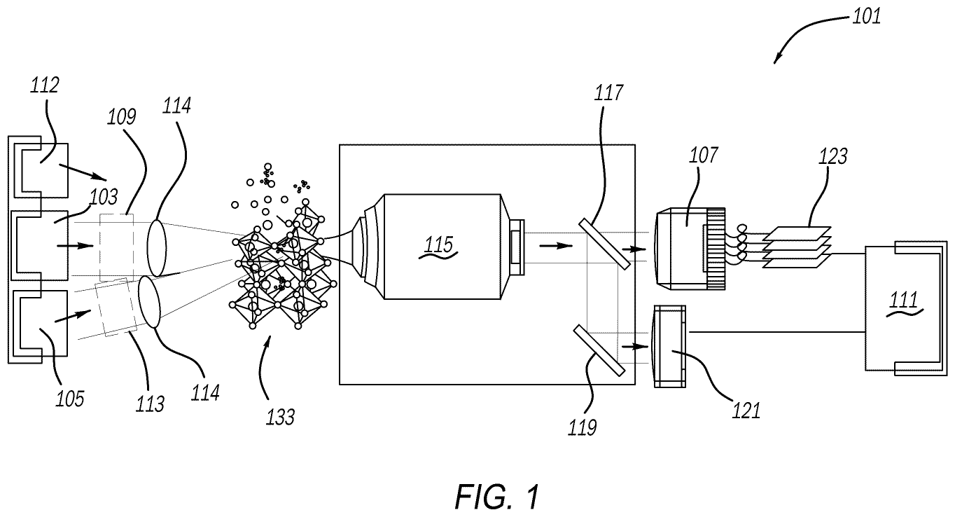

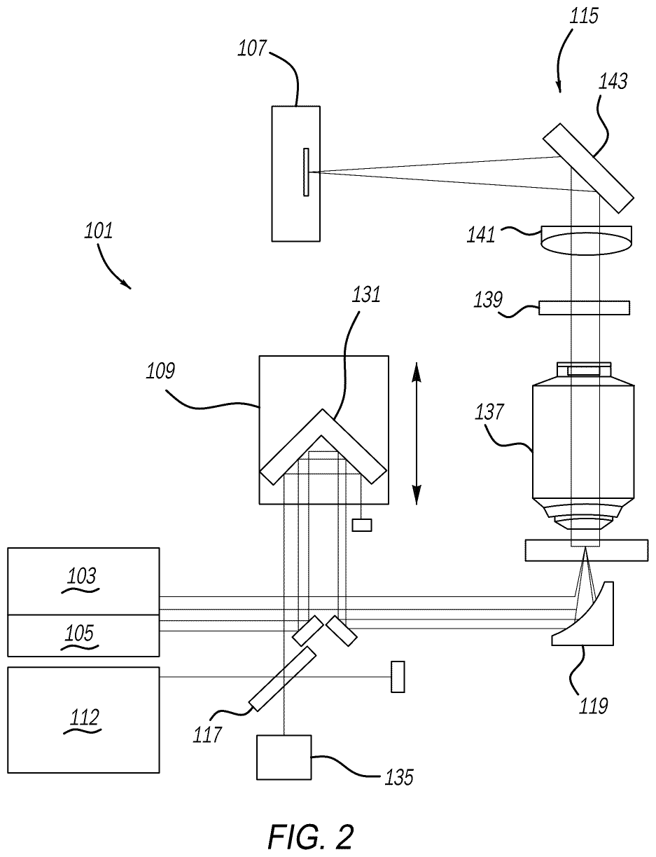

Referring to FIGS. 1-6, a preferred embodiment of the present system and method employ an electrical circuit connected to a first ultrafast pulsed laser and a second CW HeNe laser, a voice coil actuator (illustrated as the “delay” box in FIG. 2) and a camera to the programmable controller. More specifically, the present spectroscopic mapping system 101 and method of using same include at least one laser (preferably a pump laser 103 and a probe laser 105), a high speed camera 107 (for example, capturing at least 20,000 and more preferably 50,000 frames per second), a fast delay scanning voice coil 109 for imaging, and a programmable controller 111 configured to synchronize the laser(s), camera and voice coil. The VC is used to scan the delays, while the imaging occurs via the camera and widefield illumination.

Optionally, an HeNe tracer laser 112 may also be employed. System 101 also includes a modulator 113, focusing lenses 114, a microscope 115, a dichroic beam splitter 117 (separating light wavelengths), a laser pulse mirror 119 and a BF/PL camera 121. High speed camera 107 includes at least two and more preferably four, camera banks (to increase throughput speed) which are connected to at least two frame grabber circuit boards or microprocessor chips 123, which convert the raw received signal data in the camera's memory to a field programmable gate array, connected to the controller. Alternately, additional cameras may be employed, such as a dark field camera, by way of example. Alternately, the modulator, which serves to turn the pump pulses on and off, can be replaced by a deformable mirror or chopper.

Voice coil 109 includes a set of mirrors 131 which creates a delay in the pulses reflected therein. Lasers 102, 105 and 112 emit a tracer laser beam or pulse, and a pump-probe laser beam or pulse, the pump emission exciting all frequencies in a sample or specimen 133 while the probe emission (via the voice coil) vibrates the sample at different points in time. The time delay between the pump and probe pulses is modulated by the voice coil. The sample is stationary. Moreover, the time dependence of the probe transmission or reflection signal depends on the properties of the material under study.

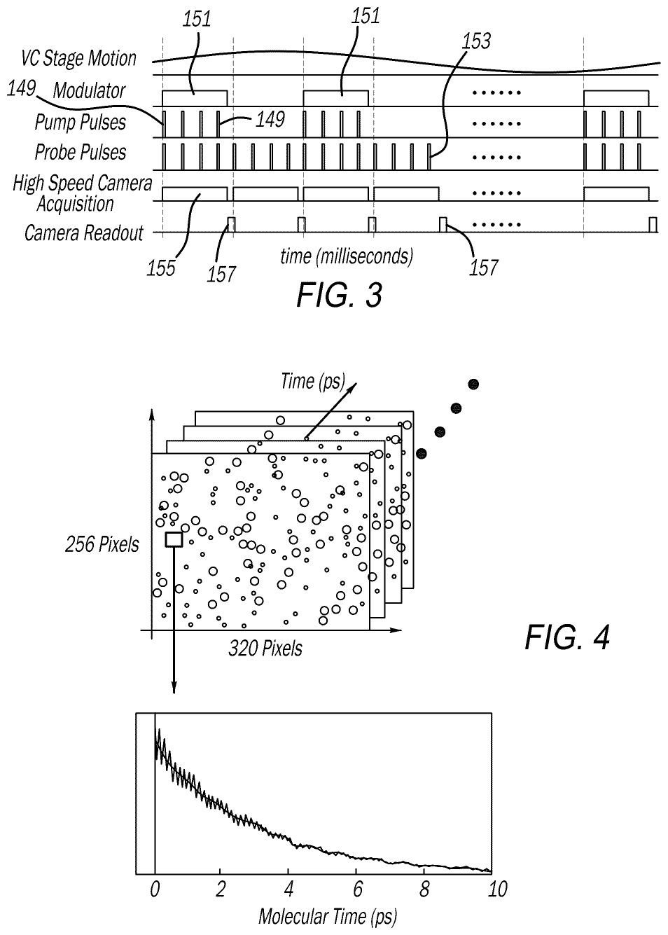

More specifically, the preferred microscope system setup includes beam splitter (“BS”) 117; a photodiode (“PD”) 135; curved mirror (“CM”) 119; an objective lens (“OBJ”) 137; a short pass filter (“SP”) 139; atube lens (“TL”) 141, and an output mirror 143. The pump and probe beams are softly focused onto the sample, with their arrival times controlled by voice coil (“VC”) 109 stage carrying a retroreflector in the probe path. Intensity modulator 113 is placed in the pump path to block alternating beams, thereby reducing background noise. A timing diagram of the synchronized hardware components, including the laser(s), camera(s), voice coil stage, and intensity modulator can be observed in FIG. 3. The components are time synchronized to the voice coil motion. The modulator and pump pulses rows show pump light pulses 149 turned on for four pulses at 151, and then turned off for four pulses therebetween. The probe light pulses 153 are always on, and the high-speed camera acquisition is essentially continuously acquiring at 155. The high-speed camera readout or output signals transmit data 157 periodically after a set of pulses, such as after four pulses.

The tracer light is used to detect the spatial position of the voice coil at the moment the camera captures the image. Yet another aspect uses parallel rapid imaging with spectroscopic mapping to conduct ultrafast coherent imaging.

The present system and method advantageously provide very fast and wide field of view imaging and analysis of the sample while generating or capturing at least 1.6 million spectra data points per second of the sample (with each spectra containing about 200 channels or points), and more preferably generating or capturing at least 350 million spectral data points per second, thereby obtaining significantly improved imaging resolution as compared to slow raster scanning methods. The spatial resolution is ˜400 nm or, more generally, about ½ the diffraction limit set by the probe. This “super-resolution” is achieved because of the nonlinearity of the signal generation process. The speed does not affect the resolution per se, but instead, the temporal resolution is set by the duration of the pulses and the speed of the acquisition.

In other words, there are two time resolutions: One is the dynamics of the states in the sample, which is captured with a resolution determined by the pulse duration (for example, less than 100 femtoseconds). The other is set by the camera acquisition and voice coil speeds. If the voice coil runs at 10 Hz, for example, then a hyperspectral data cube is captured at a maximum rate of 20 Hz. Therefore, both very fast dynamics and much slower dynamics are beneficially captured. As another example, if a material specimen is undergoing some sort of stress but that stress occurs slowly (on the hundreds of millisecond-to-second time scale), then the present system captures these hyperspectral maps at 20 Hz, so the inter-and intramolecular interaction changes can be watched or monitored in real-time.

In one optional configuration, a wide FOV generates at least 100,000 sensed image data points of the sample are obtained in less than or equal to 50 milliseconds. In another optional configuration, more than 100, and even more preferably at least 250, different color frequencies are simultaneously excited in the sample, which allows for automatically controlled imaging, measuring and analysis of sample vibration; this includes molecules in a low-frequency domain such as those peaking less than 10 THz, more preferably less than 1.0 THz, and also in a high-frequency region greater than 7.0 THz.

Returning to FIG. 1, the present PRISM method relies on the synchronized acquisition of time-resolved transmittance image sequences using high-speed camera 107, capturing pump-induced changes frame by frame in real-time. The present implementation could also be in reflective mode (epi configuration), whereby the reflected light from the sample is detected. This is beneficial for thick specimens.

In comparison to conventional point-by-point scanning used in coherent pump-probe imaging, the present pump and probe beams are softly focused to illuminate a wide field of view of about 80×80 μm². The transmitted probe beam emitted by probe laser 103, is collected by high-NA objective 114, and the scattered light from the sample is relayed to high-speed camera 107, which is capable of capturing up to 50 k frames per second (“FPS”). The time delay between the pump and probe pulses at sample 133 is controlled by high-speed voice coil stage 109 oscillating sinusoidally at 10 Hz along the probe optical path, varying the pump-probe arrival time while the camera simultaneously captures frames. To retrieve the differential transmission signal, fast laser intensity modulator 113, in the pump path from pump laser 105, operates at half the camera's frame rate, blocking alternate pump pulses. The resulting image sequence, collected while the VC stage is in motion, is stored in a three-dimensional data cube I (x, y, t), where x and y represent spatial dimensions and t represents molecular time. Additionally, bright-field (“BF”) and photoluminescence (“PL”) imaging are integrated into the system for correlative analysis, with BF/PL camera 121 capturing a single image at the beginning of each measurement. All hardware components are synchronized to ensure precise timing of signal generation, detection, and acquisition, which is desirable for data averaging and enhancing the overall signal-to-noise ratio, as depicted in FIG. 3.

In an exemplary PRISM setup, a second harmonic noncollinear optical parametric amplifier (“2H NOPA”) is used as the pump pulse source and a third harmonic (“3H”) NOPA as the probe source. Both the 2H and 3H NOPAs are pumped by the same 1028 nm femtosecond laser source with a repetition rate of 200 kHz. 35 mW pump power is delivered to the sample location with a spot diameter of approximately 80 μm, resulting in a fluence of approximately 7 mJ/cm². For the probe, a power of 3 mW is employed to maintain the same spot size, resulting in a fluence of 0.6 mJ/cm². Both the transmitted pump and probe beams are collected using a 50× objective lens with a numerical aperture of 0.42 (such as, but not being limited to, a Mitutoyo Plan Apochromat). Subsequently, the pulses are separated by the 700 nm short pass dichroic mirror. The pump beam is directed toward the photodiode for monitoring purposes, while the probe beam is sent through the 200 mm tube lens.

The resultant image at the intermediate focal plane is then relayed to the high-speed camera (such as, but not being limited to, a Phantom S710) using a pair of lenses with focal lengths of 50 mm and 100 mm, respectively. The total magnification factor of the setup is approximately 100×, designed to match the 20 μm pixel size of the camera. The theoretical field of view in the sample plane, with a 256×320 pixels camera sensor, is 51×64 μm. The actual FOV is characterized using a microscope calibration slide, resulting in measured dimensions of 46×57.5 μm. Furthermore, the probe power is adjusted to ensure that the camera operates near saturation with an exposure time of 50 μs (corresponding to a frame rate of 20 kHz) in the absence of a sample. This ensures full utilization of the camera's dynamic range, maximizing signal intensity relative to camera noise.

Further in this example, the retroreflector mounted atop the high-speed voice coil stage operates at 10 Hz and is positioned in the probe optical path to dynamically modulate the optical path length while the camera captures frames at rate of 20 KHz. Consequently, the pump-induced change in the probe transmission through the sample at the full range of pump-probe time delays employs 1000 frames within the camera image sequence. As the stage moves sinusoidally, one full scan of the pump-probe delay corresponds to a half-period of stage motion, resulting in an acquisition time of 50 ms. Since the stage movement is not linear, while the camera acquisition occurs at regular intervals, the time-domain signal is non-linearly sampled in the molecular time frame (i.e., the pump-probe delay time). As a result, linear resampling is performed on the data prior to analyzing the decay time constants or vibrational oscillation frequencies. The linear correction needs the stage position to be known at each camera frame.

Due to the rapid movement of the delay stage, its position feedback accuracy may fall short of the experimental requirements. Therefore, the real-time position of the stage is monitored using an interferometric method with the Helium-Neon (HeNe) laser. The laser beam is split into two paths: one passes through the voice coil stage while the other is reflected by a fixed mirror. The interference pattern, resulting from the combination of the two reflected beams, is detected by a photodiode and recorded by a high-speed digitizer (such as, but not being limited to, a AlazarTech) at a sampling rate of 1 M/s. As the stage moves, it changes the path length of one arm of the interferometer, leading to a shift in the interference pattern, which in turn affects the intensity detected by the photodiode. At every half period of HeNe wavelength, the stage moves a distance that represents 0.53 fs in molecular time. The interferometric method, therefore, has sufficient time resolution to accurately assign the correct pump-probe delay for each recorded frame.

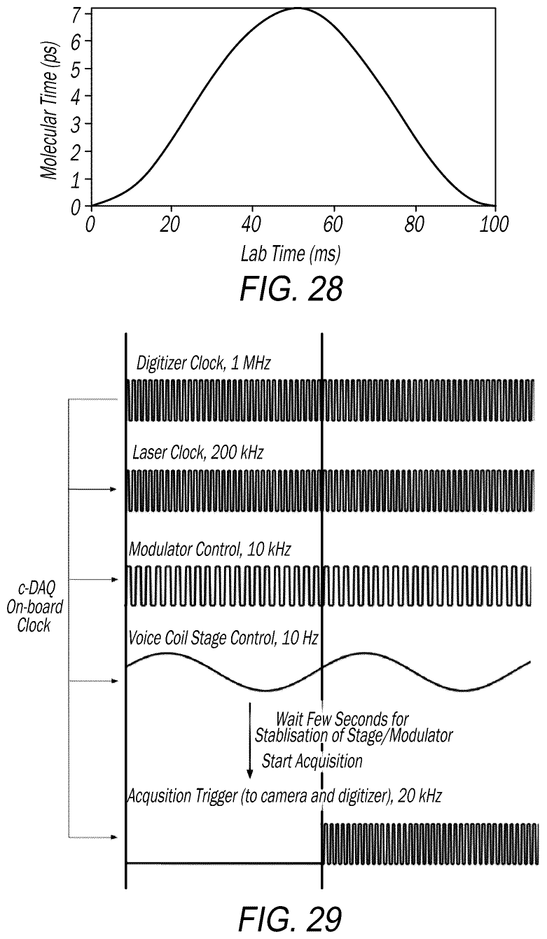

The relationship between the lab time frame and the molecular time frame is captured by a calibration curve at each stage cycle as shown in FIG. 28. Details of the resampling process based on this calibration procedure are described in the next section. While the nonlinear movement of the stage adds some complexity to the data analysis, it also offers certain advantages. Around the stage's turning point, where the velocity is nearly constant, the dynamic trace is densely sampled by the camera. By adjusting the time zero to be near this turning point, the camera finely samples the pump-induced changes occurring at early times, which may include rapid electronic responses and strong vibrational oscillations. Accordingly, this approach effectively broadens the detection bandwidth and enhances the signal-to-noise ratio for high-frequency components.

To further improve the SNR, a frame subtraction scheme is implemented utilizing a high-speed modulator to effectively chop the pump intensity at half of the camera's frame rate (10 kHz). The modulator and camera are synchronized, ensuring the camera captures alternating frames with and without pump excitation. Subtracting these alternating frames then yields the differential transmission signal at each pixel, thereby isolating the pump-induced changes and enhancing the SNR by mitigating the influence of background noise.

A comprehensive timing scheme is employed to synchronize all the hardware components, ensuring they operate on a common clock. This integration includes a high-speed digitizer for monitoring the HeNe signal, the pump modulator for chopping, the camera, the laser source and the voice coil stage. A compact data acquisition system (“c-DAQ,”) (such as, but not being limited to, one from National Instruments), features three frequency generation channels and two analog output channels, which generates the clock, triggers TTL signals, and provides analog control for the stage and modulator. All of these channels operate based on the same on-board clock, ensuring precise timing. The frequency generation channels produce 3.3 V TTL signals at 1 MHZ, 200 kHz, and 20 kHz, which are used for the digitizer clock, laser control, and acquisition trigger, respectively. One of the analog channels generates a sinusoidal signal with a 10 V amplitude to control the stage, while the other generates a 1 V square wave signal for modulator control.

As the experiment begins, the analog control signals are sent to the stage and modulator a few seconds before the acquisition to ensure the mechanical stability of these components. Subsequently, an acquisition trigger is sent to the camera and digitizer to initiate data recording. The camera captures each frame upon receiving a pulse from the 20 KHz TTL pulse train. A basic outline of this synchronization pulse sequence is shown in FIG. 29.

The data analysis automatically conducted by the present apparatus and method will now be discussed. The first step of the data analysis is image reconstruction. Due to the high frame rate of the camera, the data is continuously streamed in parallel through 16 CoaxPress channels at a speed of up to 7 Gpx/s. This parallel streaming approach differs from conventional CMOS cameras, which typically stream data sequentially, allowing for straightforward image reconstruction.

To facilitate this parallel streaming, the sensor area is divided into four banks labeled A, B, C, and D. Each bank, comprising 256×80 pixels, streams data independently. Two eight-channel frame grabbers (such as, but not being limited to, those from Euresys Coaxlink-Octo) simultaneously retrieve the data streams from these banks, temporarily storing them on the controller's random-access memory, and then writing them to a disk. Image reconstruction is subsequently carried out in Matlab. For the upper half of the image, the reconstruction process follows the bank order of D, C, B, A, line by line (256×1 pixels), while for the lower half of the image, the order is reversed. This reconstruction is performed for all the frames in the experimentally obtained image sequence.

Next, subsequent frames are subtracted to isolate only the pump-induced signal. It is noteworthy that this process results in a reduction of the experiment's time resolution by half. Following the steps of image reconstruction and frame subtraction, the image sequence is organized into a format of 256 pixels in width, 320 pixels in height, and 500 frames along the time dimension. For example, 20 continuous scans of the pump-probe delay (10 stage period, 1 s acquisition time) are performed, resulting in 20 independent image sequences. For all the data shown herein except for FIG. 13, these image sequences are averaged together after completing the reconstruction and subtraction processes to enhance the signal-to-noise ratio and improve data quality.

A subsequent step in data analysis is the linear resampling along the time dimension of the data hypercube. As mentioned, the data is initially not uniformly distributed in molecular time. To correct this nonuniform sampling, a Fast Fourier Transform (“FFT”) is first conducted along the time dimension of the data, followed by zero-padding in the frequency domain. This increased the time point density after an inverse FFT back to the time domain. Utilizing the previously measured calibration curve, pixel amplitude is estimated at each linearly spaced point in molecular time through linear interpolation. Due to the increased data density in time from the zero-padding procedure, the interpolated values are very close to the true values of the data, with discrepancies smaller than the experimental noise level. Linear resampling is thereafter carried out across all pixel values to ensure the image sequence is uniformly distributed in molecular time, setting the stage for subsequent decay time constant and vibrational oscillation analysis.

Separating the exponential decay curve from the oscillatory signal is desired to obtain an accurate spectrum. Therefore, the dataset is first fit with a multi-exponential curve along the time dimension. This approach is effective because the oscillatory signal is small compared to the exponential decay component. The data is fitted with a bi-exponential function

$$y = A exp ( - \frac{t}{{τ}_{1}} ) + B exp ( - \frac{t}{{τ}_{2}} ) + C ,$$

where τ₁ and τ₂ represent the time constants of different exponential decay components. This fitting process is performed either pixel-by-pixel or in a global manner.

In the latter case, referred to as ‘global analysis,’ the three-dimensional dataset D(x, y, t) is reduced to two-dimensions D(s, t) by flattening the spatial axis. Subsampling of the spatial dimension can be further applied to reduce the computational time. A multi-exponential model represents the entire dataset:

$${P}_{s , k} = {\sum }_{n = 1}^{N} {A}_{s n} exp ( - \frac{{t}_{k}}{{τ}_{n}} )$$

which can be simplified as P_{SK}=A_{SN}T_{NK}, with A an S-by-N matrix that contains ‘S’ terms per column corresponding to the amplitudes at each spatial point, and T an N-by-K matrix that has ‘k’ rows representing the temporal response at these spatial points. Since each exponential decay process is independent in our dataset, the T matrix essentially contains N number of exponential term with each

$${T}_{n , k} = exp ( - \frac{{t}_{k}}{{τ}_{n}} ) .$$

This matrix representation separates the multi-exponential model into two parts with one only containing the amplitude information and the other represents the exponential evolution of data in time.

Next, the best fit is found between the experimental data D and the model P by solving A and t to minimize ∥D−P(A, τ)∥². Moore-Penrose pseudo inverse of T is used to further simplify this minimization problem with A_{SN}=D_{SK}T_{KN}⁺. Consequently, τ only needs to be solved to minimize ∥D(I−T⁺T)∥². The amplitude matrix A_{SN} is calculated later with the pseudo inverse of the best fitted T. This process results in ‘N’ distinct amplitude matrices, each corresponding to a specific exponential decay process; these matrices are then presented as intensity maps for each decay time constant.

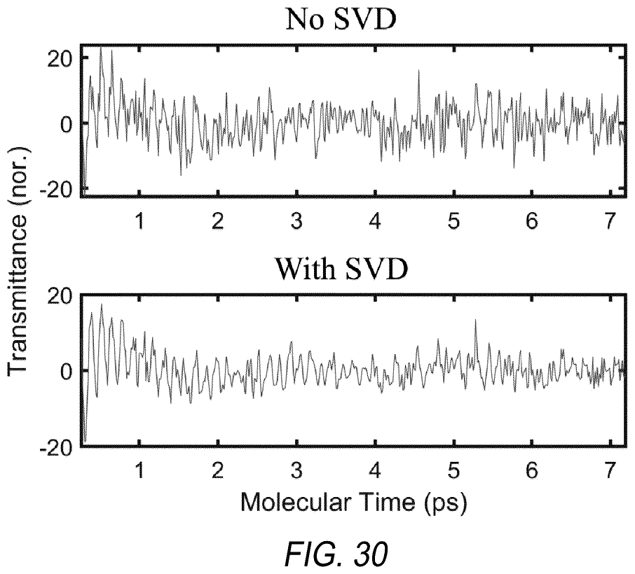

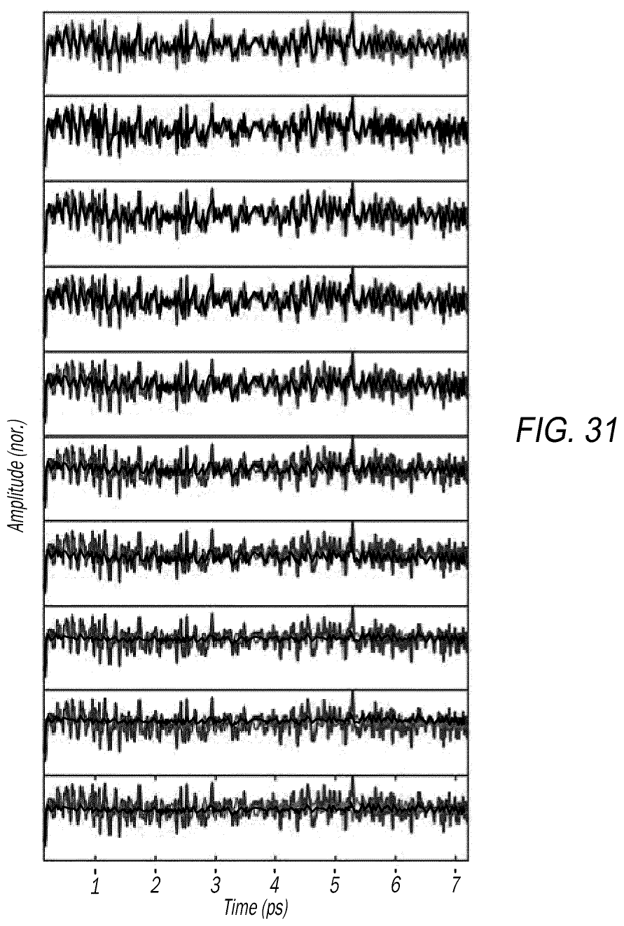

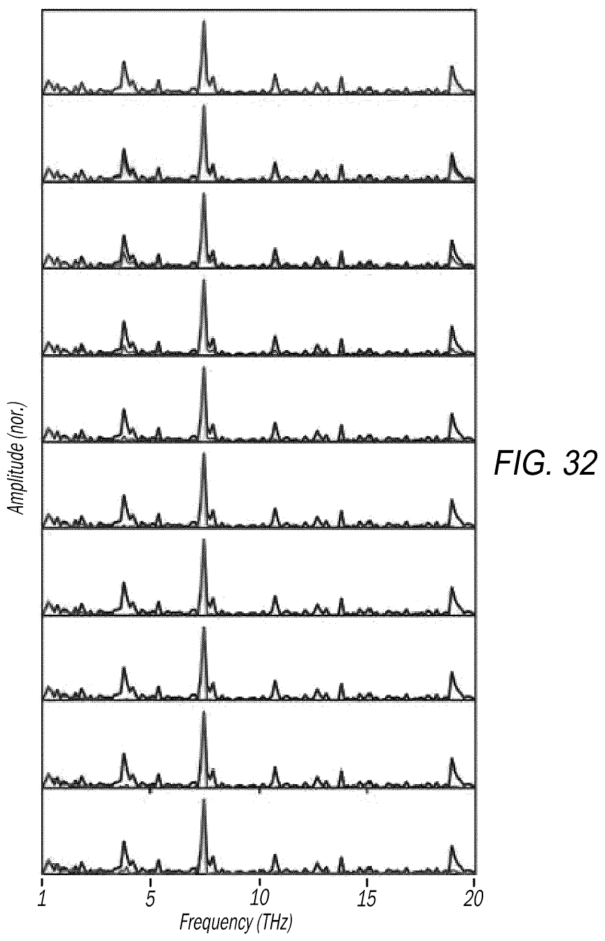

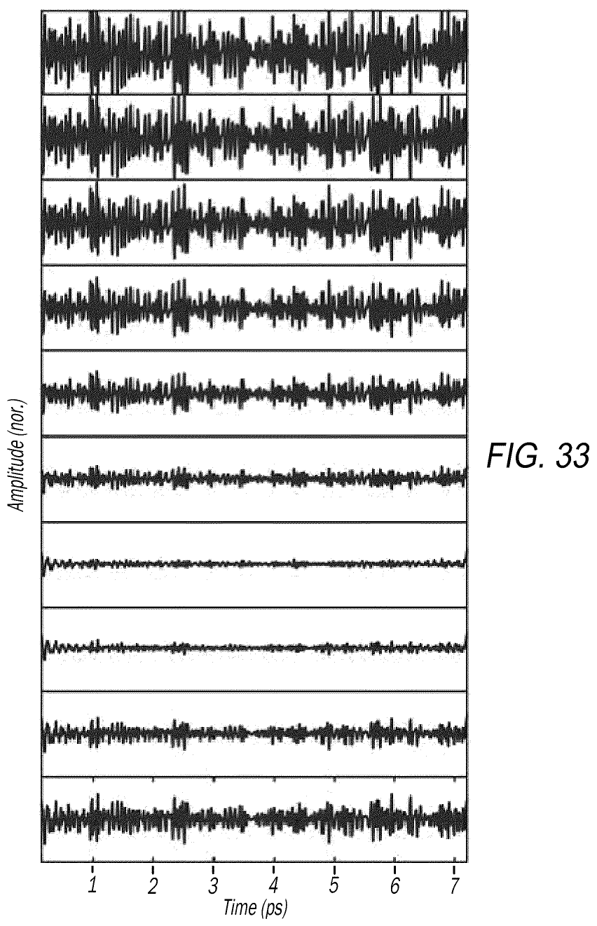

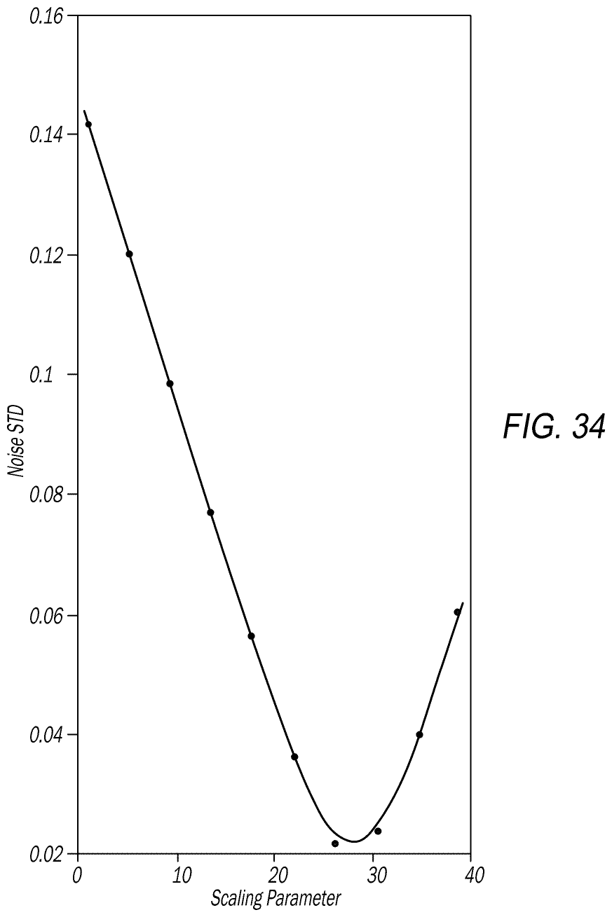

After the exponential decay components are determined, the fitted results are subtracted from the original data, O=D−P to isolate the pure oscillatory components, and then a Fast Fourier Transform is applied along the time dimension to generate hyperspectral maps. Furthermore, a Singular Value Decomposition (“SVD”) is applied on the spatial-temporal residual O(s, t) to enhance the image quality of the hyperspectral maps. The SVD approach helps isolate the signal from noise by identifying modes that capture spatial patterns and their evolution in time. Moreover, the dataset O is decomposed to singular vector and singular values following the relation O=USV, where U and V are left and right singular vector matrix, and S is singular values. The first eight most significant singular values are retained, which contribute predominantly to the signal, and the remainder are discarded, which are mainly dominated by noise. FIG. 30 compares the WSe₂ single-pixel time trace with and without the application of SVD.

A denoising approach is also applied during data analysis (before SVD) to minimize additive noise from the PRISM measurements, utilizing a non-sample region as a reference. This method is feasible due to the high correlation of noise across the image—an advantage of the wide-field approach. This approach involves selecting a region with no sample present and multiplying its time trace by a scaling factor to identify the optimal denoising point. This approach involves selecting a region with no sample present (reference region) and correlating this reference data to all the image pixels for the probe only frames. Then, this correlation matrix is used to generate an approximation to the local oscillator (“LO”) by multiplying it with the reference data for the pump+probe frames. The LO is subsequently subtracted from the pump+probe frames for all the image pixels. The LO is part of the probe light that is used for heterodyne detection, boosting the amplitude of the signal. The entire image's time trace is then processed by subtracting the scaled reference region's time trace to effectively reduce noise.

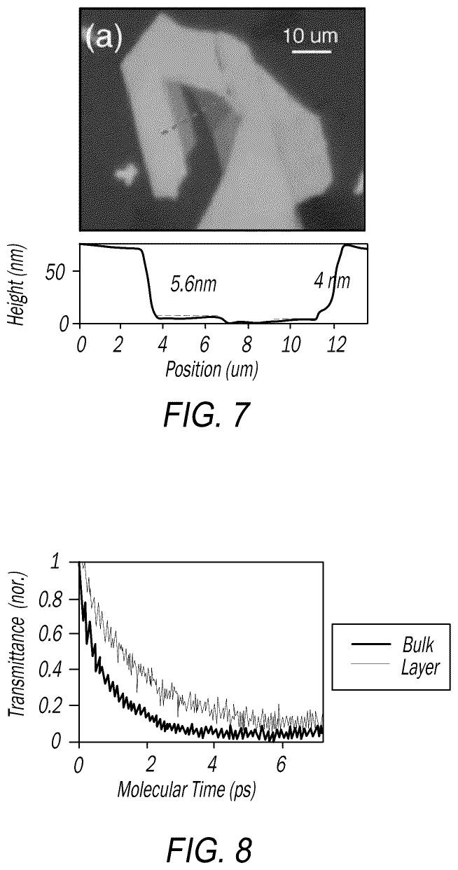

Different acquisition speeds are compared hereinafter. FIGS. 7-13 compare PRISM results obtained with different acquisition times, ranging from a single scan to 10 averaged scans. The population intensity maps, primarily influenced by exponential decay dynamics, show little change with reduced acquisition time. However, phonon intensity maps are more sensitive to these variations.

At the 250 ms acquisition, both population and phonon intensity maps maintain a high SNR, comparable to those in FIGS. 7-13. Reducing the acquisition time further affects the quality of the phonon map, but essential spatial features are still visible down to the 50 ms limit. Faster scanning may be achieved by reducing the scan range at the cost of reduced spectral resolution. These results highlight PRISM's capacity for over one million dynamic traces and spectra per second, with a significant potential for further optimization through hardware and software upgrades, such as faster cameras and delay control schemes, as well as advanced image denoising techniques.

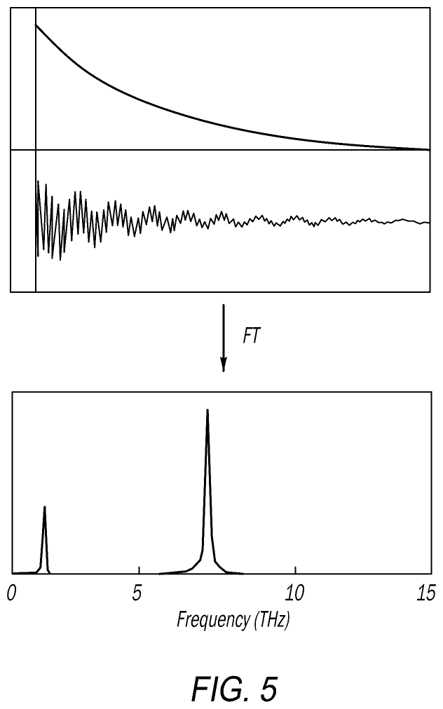

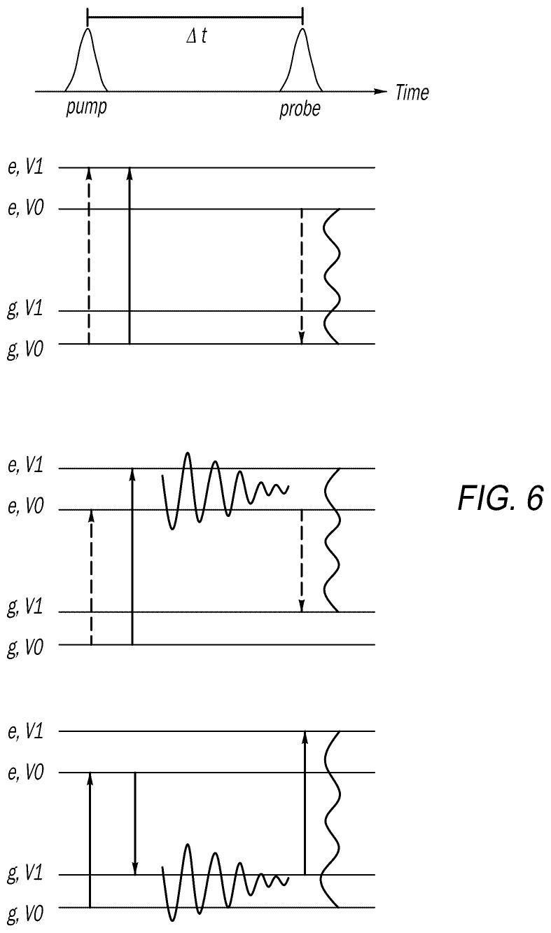

FIGS. 4 and 5 show a conceptual typical image sequence obtained from PRISM measurements. Each single pixel in the image sequence captures both the electronic state decay dynamics over molecular time, and high frequency coherent oscillations which may represents ground-or excited-state vibrations, or mixed electronic-vibrational (vibronic) quantum superpositions (FIG. 6). Analyses of the time-resolved image sequence allow for the retrieval of the lifetime of the electronic states, as well as the energy and dephasing rate associated with each vibrational coherence. To increase the computationally efficiency, the 3D data cube is processed with a global analysis approach which separates the high-frequency oscillatory signal from the low-frequency exponential decay. The oscillatory signal is subsequently transformed into the vibrational spectrum using the fast Fourier Transform, revealing distinct frequency components associated with different vibrational coherences.

Programmable controller 111 includes programmable software instructions used in a microprocessor and stored in non-transient RAM or ROM memory. The software instructions analyze and measure the GB of data received by the camera, including comparing and correlating spatial versus frequency versus a K-rate time constant from the data. The software instructions also optionally correlate the data to external morphology data (such as that shown in the graph of FIG. 12).

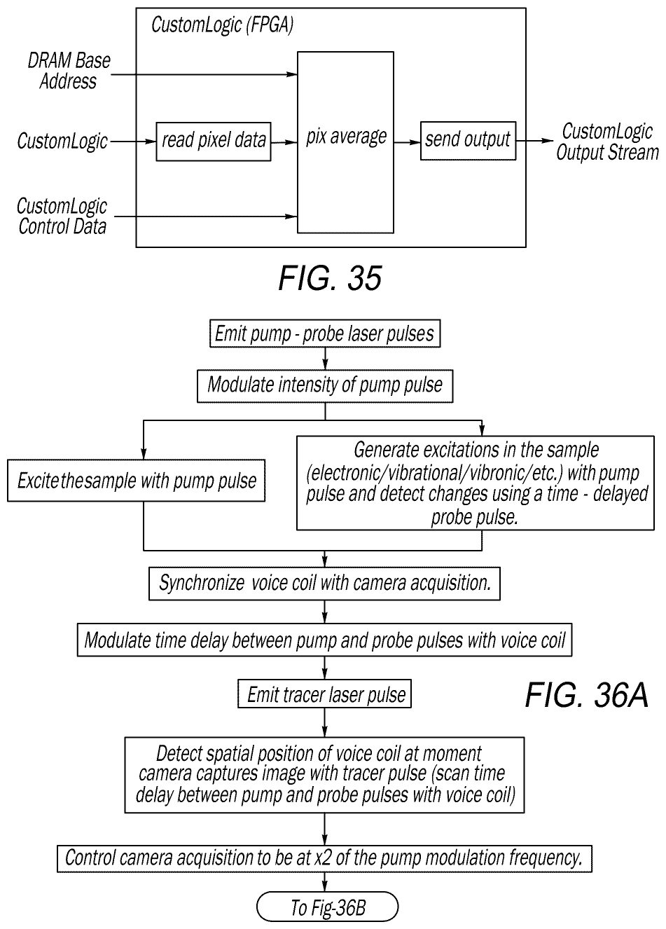

FIG. 35 shows the logic flow of a field-programmable gate array (“FPGA”), whereby some of the processing steps can be performed in hardware rather than software to greatly accelerate image processing. In principle, all the processing steps may be performed on the FPGA and therefore display an image with contrast based on the phonon frequencies or other dynamical information not possible with standard cameras.

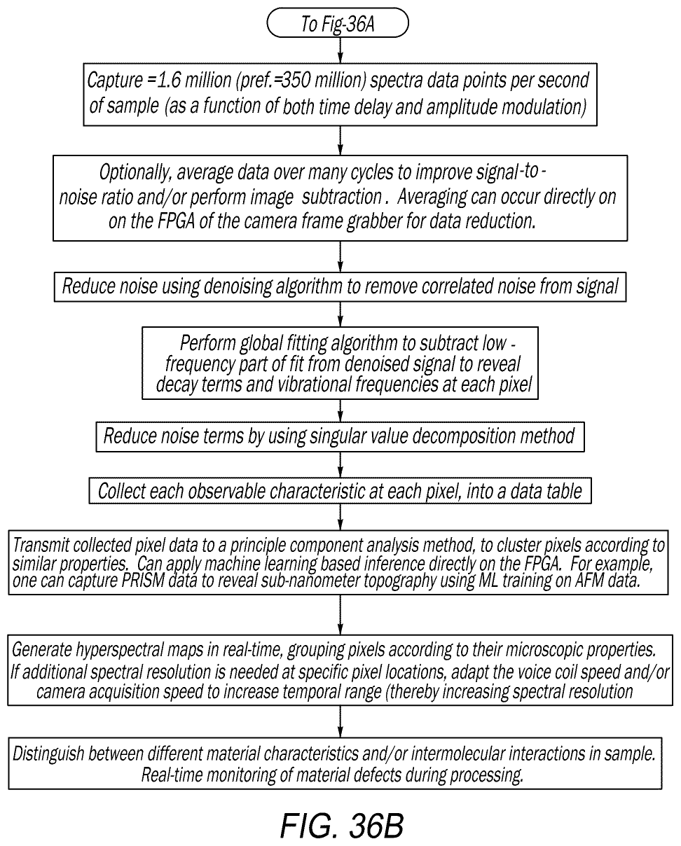

The logic and method employed in the software instructions run by the programmable controller is illustrated in FIGS. 36A and 36B. The logic steps include:
Emitting pump-probe laser pulses;
Modulating intensity of the pump pulse;
Exciting the sample with the pump pulse;
Generating excitations in the sample (electronic/vibrational/vibronic/etc.) with the pump pulse and detecting changes using a time-delayed probe pulse;
Synchronizing the voice coil with camera acquisition;
Modulating time delay between the pump and probe pulses with the voice coil;
Emitting the tracer laser pulse;
Detecting spatial position of the voice coil at the moment the camera captures the image with the tracer pulse (scan time delay between pump and probe pulses with the voice coil);
Controlling the camera acquisition to be at x2 of the pump modulation frequency;
Capturing≥1.6 million (pref.≥350 million) spectra data points per second of the sample (as a function of both time delay and amplitude modulation);
Optionally, automatically averaging the data over many cycles to improve the signal-to-noise ratio and/or perform image subtraction. The averaging can occur directly on the FPGA of the camera frame grabber for data reduction.
Reducing noise using the denoising algorithm to remove correlated noise from the signal;
Performing the global fitting algorithm to subtract the low-frequency part of fit from the denoised signal to reveal decay terms and vibrational frequencies at each pixel;
Reducing the noise terms by using the singular value decomposition method;
Automatically collecting each observable characteristic at each pixel, into a data table;
Transmitting the collected pixel data to a principle component analysis method, to cluster the pixels according to similar properties. Can optionally apply machine learning based inference directly on the FPGA. For example, one can capture PRISM data to reveal sub-nanometer topography using ML training on the AFM data.
Generating hyperspectral maps in real-time, grouping the pixels according to their microscopic properties. If additional spectral resolution is needed at specific pixel locations, adapting the voice coil speed and/or the camera acquisition speed to increase temporal range (thereby increasing spectral resolution).
Automatically distinguishing between different material characteristics and/or intermolecular interactions in sample, including optional real-time monitoring of material defects during processing.

The software instructions can also generate frequency maps, whereby a coherence frequency is assigned to each pixel. In one configuration, the present software instructions display intensity maps, which correspond to the strength/amplitude of a given frequency at each pixel. However, the frequency maps are different as they are much more tied to the structure of the material, such that these frequency maps may more directly correlate to AFM and other structural probes, in an alternate configuration.

The method of operation steps are summarized as follows: Data is streamed into the frame grabber of the camera. The camera operates at a high frame rate (typically greater than 10,000 frames per second), by which it records a light transmitted, reflected or scattered off the sample or specimen by the probe pulse. A second pump pulse which precedes the probe is used to excite the sample according to different mechanisms by which the sample interacts with the pump light according to its nonlinear optical susceptibility. The voice coil stage is used to rapidly scan the time delay between the pump and probe pulses (typically at rates from 10-1,000 Hz). Further, the pump light is modulated in intensity using one of different types of the modulators, for example, an acoustic optic modulator, a deformable mirror, a digital micromirror device, a chopper, or the like. Therefore, the camera records frames as a function of both the time delay induced by the voice coil stage and the amplitude modulator. Moreover, data may be averaged over many cycles of the stage to improve the signal-to-noise ratio.

As shown in FIG. 35, the data streamed to the frame grabber is stored inside the memory of the field-programmable gate area chip. The FPGA chip is programmed with the software instructions to perform both image subtraction (pump on minus pump off) and averaging (over multiple cycles of the voice coil). It can also perform more advanced operations such Fourier transformation or even inference in a machine learning context.

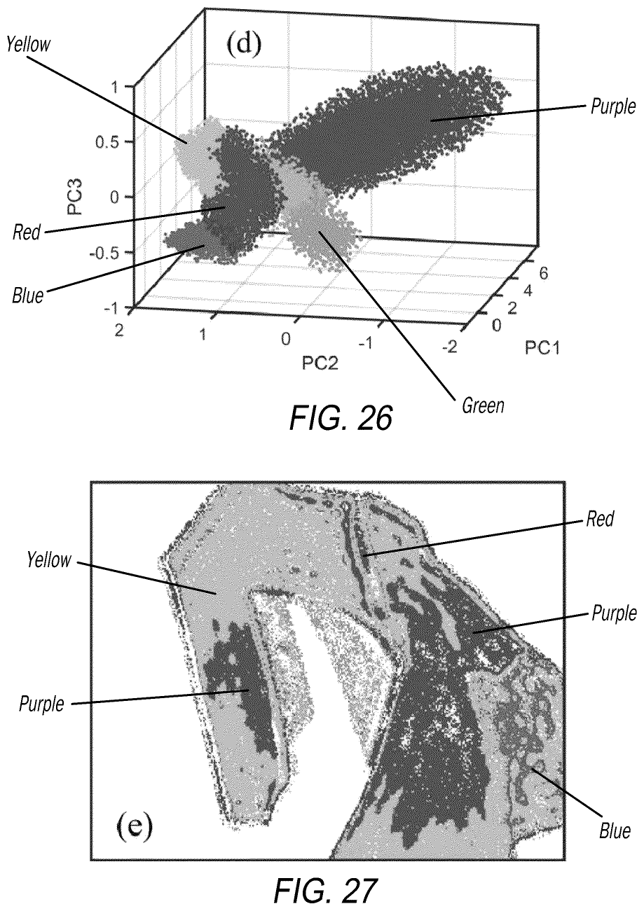

The output data is transferred to the controller from the FPGA and the software instructions and controller then organized the data as a three-dimensional hypercube of data (spatial x,y, and time delay t), which is referred to as S_{(x,y,t)} or simply S, like that illustrated in FIG. 26. Thereafter, the software and controller use the denoising algorithm to remove correlated noise from the signal in S. The global fitting algorithm is then automatically calculated by the software and controller to the denoised signal. Subsequently, the software and controller may then optionally further reduce the noise terms contained in the higher singular values using the singular value decomposition calculation. The software instructions and controller collect in a table each observable signal/data at each camera pixel (e.g., vibrational frequency, linewidth and intensity; decay time constants; and any other correlative measurements made such as brightfield/darkfield/ photoluminescence, etc.) with each pixel representing a row and each observable a column. This data is then passed to a principle component analysis calculation or other unsupervised learning method. These procedures automatically (or less preferably manually) cluster the pixels according to similar properties, which then allows the user to generate a new hyperspectral map to group pixels according to their microscopic properties. The controller finally shows this map and data on an output display screen or the like.

### EXAMPLES

Measurements on three different materials, tungsten disel enide (WSe₂), methylammonium lead bromide (MAPbBr₃) and mixed iodide-bromide methylammonium lead (MAPb(BrₓI₁₋ₓ)₃) perovskite crystal, are performed to demonstrate the expected capability of the present PRISM system and method. FIG. 7 shows the bright-field image of the WSe₂ sample used in this study, where regions of few-layer thickness are surrounded by bulk material. With its distinct vibrational spectra, characterized by high-frequency intra-layer vibrations and low-frequency inter-layer vibrations, WSe₂ serves to demonstrate PRISM's capability in identifying the influence of structural heterogeneity on molecular interactions. Atomic force microscopy (“AFM”) confirmed that the WSe₂ bulk region's thickness is about 72 nm, equating to around 100 layers given a monolayer thickness of ˜0.7 nm, whereas the few-layer regions measured 5.6 nm and 4 nm in thickness, corresponding to about 8 and 6 layers respectively.

By tuning the pump wavelength to 750 nm with a spectral width of about 30 nm, the A-exciton absorption band of WSe₂ near 760 nm is targeted, optimizing pump absorption efficiency and enhancing both carrier population and coherent phonon signal strength. When the pump energy exceeds the bandgap, coherent phonon excitation primarily occurs through the displacive excitation of coherent phonons (“DECP”) mechanism, where the spatial redistribution of optically excited electrons shift the lattice equilibrium and generates coherent phonons. In this case, electrons and phonons are highly coupled, with the electronic redistribution directly influencing lattice vibrations (i.e. phonon coherences). Simultaneously, impulsive stimulated Raman scattering contributes to the phonon spectrum, although less prominently due to the inefficient two-photon process. Further, the probe was tuned to an optimized wavelength of 650 nm with a spectral width of about 20 nm, balancing efficient absorption with sufficient separation from the pump wavelength.

PRISM utilizes soft focusing of the pump and probe beams to illuminate a wide field of view of about 80 μm². A high-speed camera captures the probe light transmitted through the sample at 20,000 frames per second with a dynamic pump-probe delay scan at 10 Hz. The time-resolved image sequence is compiled into a three-dimensional hypercube with spatial (x and y) and time delay (Δt) dimensions. The pump pulse creates either a population in the excited state which decays with time, or a super-position state (coherence) in either the ground-or excited-states, as is shown in FIG. 6. These coherences may encode ground-or excited-state vibrations, or pure electronic or mixed electronic-vibrational (vibronic) quantum superpositions. The probe pulse, depending on its energy relative to allowed single-quantum transitions between electronic states, either returns the system to the ground state (stimulated emission) or promotes it to an accessible excited state (ground-state bleach or excited-state absorption).

Analyses of the time-resolved image sequence allow for the retrieval of the exponential decay behavior of excited-state relaxation, as well as the energy and dephasing rate associated with each coherence. Data analysis can proceed ‘point-by-point,’ which is computationally intensive, or through a more efficient global analysis approach, which identifies common features across the entire dataset, reducing fitting time from hours to seconds. Global analysis produces N decay maps corresponding to the number of exponential components in the dataset. The oscillatory signal (AC) is isolated by subtracting the fitted hypercube of decay components from the original data. A fast Fourier Transform applied to this AC signal yields hyperspectral images, generating a coherence map for each spectral component. To further enhance image quality, strategies such as data averaging and singular value decomposition can be employed to minimize noise.

A few-layer tungsten diselenide (WSe₂) is selected as a benchmark in this example to validate the widefield method because its optical properties vary with layer number. WSe₂, forming a hexagonal lattice with layers bonded through van der Waals forces, displays characteristic vibrational spectra: high-frequency intra-layer and low-frequency inter-layer vibrations. By setting the pump wavelength to 750 nm and a spectral width of about 30 nm, the A-exciton absorption band near 760 nm is targeted, which optimizes pump absorption efficiency, enhancing both carrier population and coherent phonon signal strength. With the pump energy higher than the bandgap, the primary mechanism for coherent phonon excitation is attributed to the displacive excitation of coherent phonons mechanisms, where the optically excited electrons' spatial redistribution shifts the lattice's equilibrium, creating coherent phonons. Simultaneously, impulsive stimulated Raman scattering contributes to the phonon spectrum, although less prominently due to the inefficient two-photon process. The probe is tuned to an optimized wavelength of 650 nm with a spectral width of about 20 nm, balancing efficient absorption with a sufficiently distinct pump wavelength. This distinction is effectively separates the detected signal from the intense pump light, especially within the collinear setup desired for high-resolution microscopy.

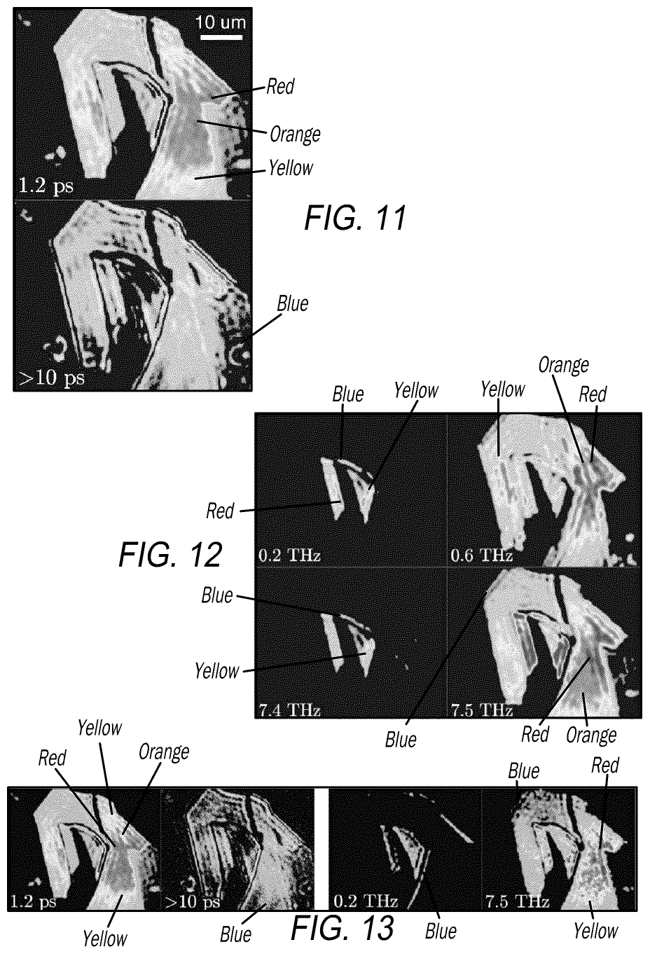

The sample is prepared via mechanical exfoliation, opting for a multifaceted topology, like that shown in FIG. 11, where areas of few-layer thickness are surrounded by bulk regions. This approach establishes a proof of concept since phonon modes, particularly interlayer modes, are highly layer-number dependent, in contrast to chemical vapor deposition (“CVD”) which produces uniform layers. Atomic force microscopy confirms the bulk region's thickness at approximately 72 nm, equating to around 100 layers given a monolayer thickness of ˜0.7 nm, whereas the few-layer regions measured 5.6 nm and 4 nm in thickness, corresponding to about 8 and 6 layers respectively. The wide disparity in thickness introduces significant challenges in probing the entire structure which exhibits a wide dynamic range in signal intensity.

The PRISM technique captures time-resolved images across the entire FOV, averaging over 10 scans for a total acquisition time of one second. FIG. 12 displays a single frame from the wide-field image sequence. To interpret molecular interactions within various areas of the flake, three distinct spatial masks are employed, isolating the bulk, few-layer regions, and edges. Precise identification is achieved due to the high spatial resolution of the measurement attributed to the nonlinear signal generation process. Initially, point-by-point exponential fitting is employed to find the population time constants. To enhance spectral resolution, zero-padding of the time domain data is next done before applying FFT for spectrum generation. Utilizing the comprehensive dataset from PRISM, a correlation analysis is performed between the time constant and phonon frequencies of these specific regions.

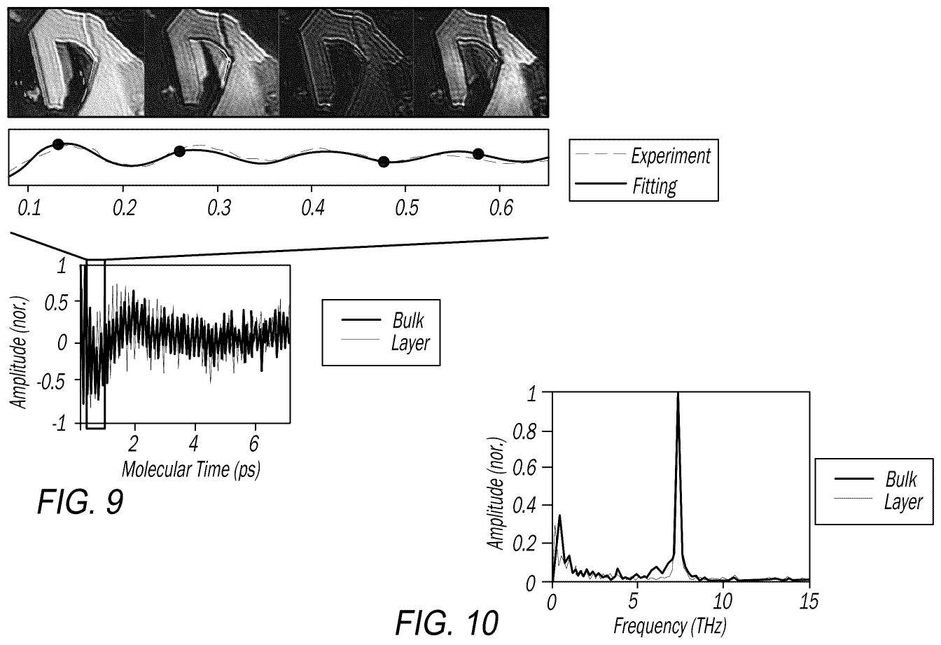

FIGS. 8-10 compare the normalized transmittance as a function of pump-probe delay, the isolated oscillatory components, and the vibrational spectrum of a single pixel in the layer (blue) and the bulk region (red). Changes in both the decay dynamics and the vibrational spectrum can be observed as the sample thickness varies. In the oscillatory components shown in FIG. 9, both high-frequency and relatively low-frequency components are evident. Examining the first 700 fs, as highlighted in the black box above panel FIG. 9, reveals that the signal fits a decaying sinusoidal function, characteristic of typical vibrational oscillations. The images captured by the high-speed camera at different molecular times (yellow points), after subtracting the exponential components, reveal intensity variations across the entire flake caused by high-frequency vibrational oscillations.

Two sets of maps intuitively highlight this heterogeneity across the flake: the time constant maps (FIG. 11) and the hyperspectral maps (FIG. 12). Two decay components are identified during the global exponential fitting of the original data cube, with one time constant around 1.2 ps and another exceeding 10 ps. The intensity maps of these two components, shown in FIG. 11 top and bottom, reveal the bi-exponential decay characteristics of WSe₂ across the few-layer and bulk regions. It is noteworthy that the decay time constant exceeding 10 ps, associated with the A-exciton lifetime, is identified throughout the fit, but the 7.2 ps delay scan range limits capturing the full decay curve, resulting in a larger uncertainty.

FIG. 12 displays hyperspectral maps at four different frequencies. Distinct spatial features of few-layer and bulk are evident. In the sub-THz region, characterized by interlayer phonon modes, few-layer and bulk regions exhibit different intensity maps at frequencies of 0.2 THz and 0.6 THz, respectively. The 0.2 THz mode (˜6 cm⁻¹) may be associated with the first order out-of-plane interlayer breathing mode in structures consisting of 6-8 atomic layers. Around 0.6 THz (˜20 cm⁻¹), the bulk region exhibits a stronger signal, which can be attributed to interlayer shear motion within the bulk material. It is noteworthy that the frequency resolution limit of 0.14 THz introduces uncertainty in determining the exact center frequencies. In the high-frequency region, the peak near 7.5 THz is attributed to the A_{1g} phonon mode. Furthermore, other Raman active modes such as E¹_{2g}, B¹_{2g} and LA(M), have insignificant contribution to the spectrum, likely because the DECP mechanism is dominant, resulting in fully symmetric modes having significantly stronger intensity.

The coherence maps reveal that both the few-layer and bulk regions exhibit frequency components at 7.5 THz, whereas only the few-layer region displays the 7.4 THz components. This redshift and broadening of the A_{1g} mode can be attributed to increased electron-phonon coupling, resulting from weakened interlayer interactions and lattice softening induced by quantum confinement effects. The reduction in interlayer coupling makes phonon modes more responsive to electronic excitations, while quantum confinement further intensifies this interaction by increasing the overlap between electronic states and phonon vibrations.

The measurements in FIGS. 8-12 are signal-averaged 20 times to enhance the SNR, resulting in a total acquisition time of 1 seconds. However, as previously noted, a full PRISM measurement can be completed within 50 milliseconds. Thus, the resulting time constant and hyperspectral maps are presented in FIG. 13. The time constant maps, which primarily reflect exponential decay dynamics, exhibit minimal variation with reduced acquisition times. In contrast, the hyperspectral maps show greater sensitivity to changes in acquisition time. Nevertheless, both the time constant and hyperspectral maps reveal the decay and vibrational characteristics consistent with the averaged results. Further improvements on acquisition speed are achievable with faster cameras, enhanced delay control mechanisms and/or the application of advanced image denoising techniques.

Next, PRISM measurements are conducted on solution-processed MAPbBr₃ and MAPb(BrₓI₋ₓ)₃ perovskite microcrystals. Solution-processed perovskite materials are known to exhibit inherent heterogeneity, including variations in composition, morphology and structural properties. It has been suggested that in metal halide perovskites, excellent carrier mobility and extended lifetimes result from large polaron formation, driven by electron-phonon coupling as electrons polarize and distort the soft lattice. This electron-phonon interaction is highly sensitive to the microenvironment, where local variations influence coupling strength and alter the spatial distribution of charge carriers, ultimately affecting key optical properties such as absorption and photoluminescence (PL) efficiency. While most studies focus on heterogeneity between different crystals, these two examples are selected to demonstrate PRISM's ability to evaluate heterogeneity within a single crystal. Additionally, perovskites at room temperature typically present a broad vibrational spectrum at relatively low frequency which is difficult to measure using other spectroscopic imaging methods such as CARS or ISRS.

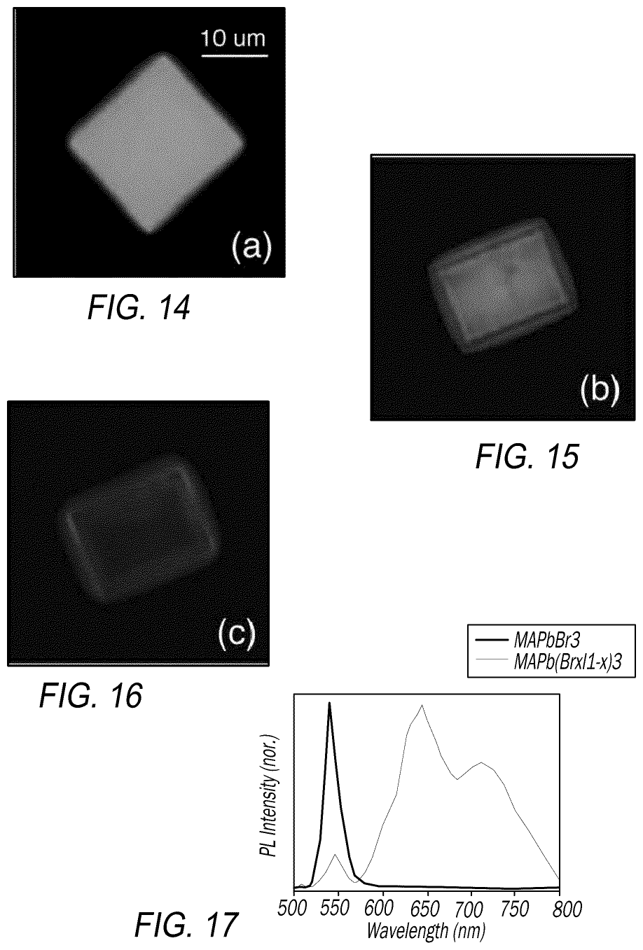

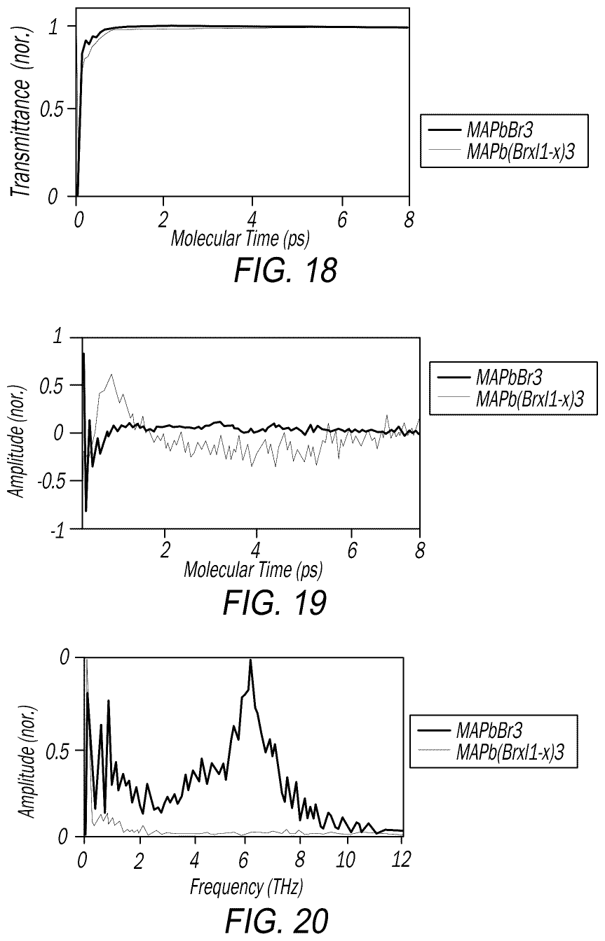

FIGS. 14-16 show PL images of MAPbBr₃ and MAPb(BrₓI₋ₓ)₃ crystals, captured at the start of each synchronized PRISM scan. The PL spectra of the two types of crystals are shown in FIG. 17. For MAPbBr₃, the PL peak is centered around 540 nm, while partial substitution of bromide ions with iodide leads to a redshift in the bandgap, resulting in a broader PL wavelength distribution in the 600-800 nm range. FIG. 18 shows the normalized time-resolved transmittance change of a single pixel located at the center of the crystal from the PRISM measurements.

It is evident that replacing part of the bromide atoms with iodide alters the time-resolved response. The isolated oscillatory components shown in FIG. 19, highlight distinct vibrational dynamics between the two types of perovskites, with these differences further emphasized in the spectra shown in FIG. 20. For MAPbBr₃, two broad peaks are identified, spanning the 0-2 THz and 4-9 THz regions. The 0-2 THz peak corresponds primarily to lattice vibrations (TO/LO phonons), while the higher-frequency peak is associated with the torsional motion of the methylammonium (MA) cation, coupled to the halide cage. In MAPb(BrₓI₋ₓ)₃, the 4-9 THz mode is significantly quenched, likely due to the altered bond strength and bond length within the halide cage. This quenching could also be attributed to the resonant pump excitation in MAPb(BrₓI₋ₓ)₃, where the low-frequency modes are coupled with the electronic excitation, leading to modifications in the intensity of the high frequency peak.

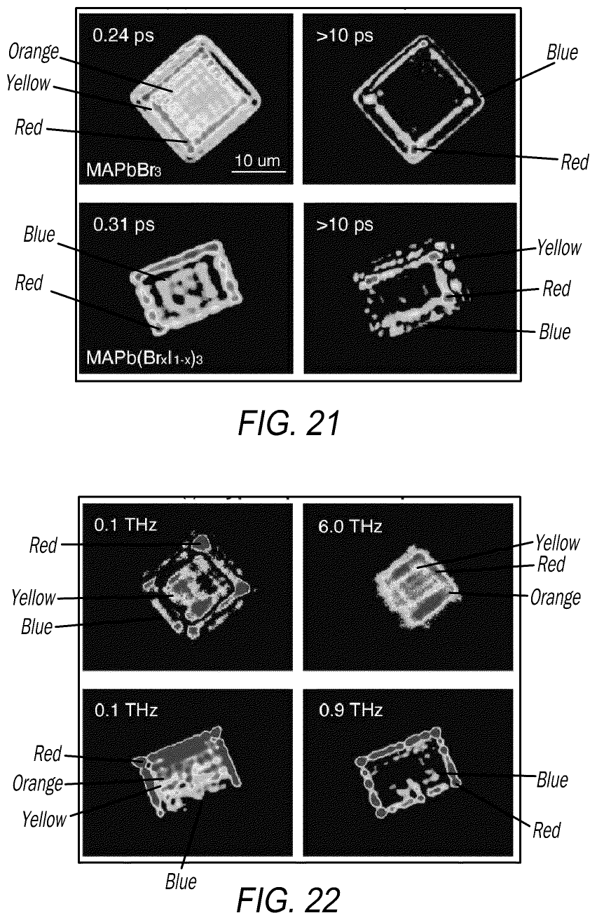

Heterogeneity is not easily discernible through PL imaging in single-crystals, as is indicated by FIGS. 14-16. In contrast, PRISM measurements, as shown in FIGS. 21 and 22, reveal spatial variations in both the electronic and vibrational properties within the single crystal. The decay time constant intensity map in FIG. 20 identifies two decay components: a fast component (<0.5 ps), attributed to hot carrier thermalization to the band edge, and a slower component (>10 ps) that appears primarily near the crystal edge, potentially indicating recombination through surface states caused by local strain-induced lattice distortions. The present measurements focus on the first few picoseconds after time zero to resolve phonon oscillations and dephasing; the slow recombination channels that typically occur on the nanosecond scale in perovskites are treated as a constant during the fitting process.

The hyperspectral maps in FIG. 22 further demonstrates the microcrystal's heterogeneity. In MAPbBr₃ crystals, a low-frequency phonon mode associated with lattice motions is detected at the crystal edge, while a higher-frequency mode around 6 THz, attributed to MA cation motions, is more pronounced at the crystal center. In contrast, for MAPb(BrₓI₋ₓ)₃ crystals, the low-frequency mode near 0.1 THz appears uniformly throughout the crystal, whereas the 0.9 THz mode is localized specifically at the edges. The edge phonon mode in both types of crystal likely arise from lattice distortions at the edge termination. For MAPb(BrₓI₋ₓ)₃ this mode may also reflect compositional variations due to phase segregation, which often initiates at grain boundaries. Moreover, the distinctive characteristics of electronic decay and the phonon mode at the edges, compared to the crystal center, suggest that different types of polarons may form at or near this region.

PRISM's ability to capture both carrier and vibrational dynamics simultaneously paves the way for exploring correlations between these properties. Such correlation can reveal changes in relaxation and recombination rates due to carrier-phonon coupling, as well as spectral shifts resulting from carrier-induced lattice distortions. To conduct this correlative analysis, it was desired to distinguish subtle spatial variations in decay constants. Therefore, a point-by-point fitting of the exponential decay terms is performed to capture the variance in the parameters across different regions. The expected results show that in the few-layer region, the decay time constants exhibit a broader range (1.0-1.5 ps) compared to the bulk region (1.2-1.4 ps). This broader distribution in the few-layer region may arise from surface and defect states introducing additional relaxation pathways, as well as the presence of multiple phonon modes with varying coupling strengths, leading to a more diverse range of decay times.

The expected PRISM results are correlated with bright-field image. The bright-field microscope can distinguish WSe₂ layers up to a few layers thick, as each additional layer significantly alters light absorption, refractive index, and interference effects, creating visible contrast. However, as thickness increases, probing morphological changes in these regions becomes increasingly challenging, necessitating the use of alternative techniques such as AFM. Here, we integrated bright-field microscopy with PRISM to provide a complementary approach for enhanced heterogeneity characterization.

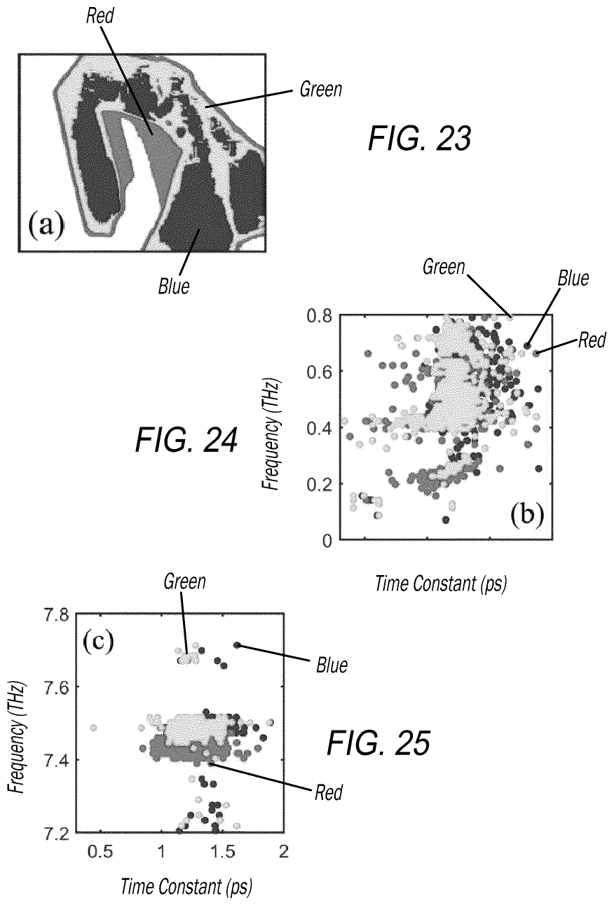

Based on the bright-field transmittance, we segmented the sample into three distinct regions, as shown in FIG. 23, and correlated the decay time constants with vibrational frequencies (FIGS. 24 and 25), revealing signal clustering corresponding to specific spatial components. In these regions, the red area primarily represents the few-layer region and edges, while the blue and green regions correspond to bulk areas. Along the decay time axis, phonon peaks cluster around a 1.2 ps time constant, consistent with the global analysis results. The average decay time constants for the three regions are 1.23 ps (red), 1.3 ps (green), and 1.34 ps (blue), respectively. For vibrational modes, clustering is observed in the low-frequency domain, with peaks around 0.2 THz and 0.5-0.7 THz across the different regions. In the high-frequency range, the phonon mode in the few-layer region shows a slight red shift at 7.43 THz compared to 7.48 THz in the bulk region. These observations are consistent with the trends identified in FIGS. 7-13, further highlighting the spectral differences between few-layer and bulk dynamics.

While subtle differences between regions are observed, the decay rates and phonon frequencies show strong overlap across spatial regions, making it challenging to disentangle dynamic effects influenced by sample heterogeneity. To further leverage the correlative data to reveal subtle sample heterogeneities, principal component analysis (“PCA”) is conducted based on seven variables: the fast and slow decay components, four specific spectral peaks (0.2, 0.6, 7.4, and 7.5 THz), and bright-field transmittance. The expected PCA results, shown in FIG. 26, reveal distinct clustering of data along the principal components, indicating spatial variations within the material.

Based on these results, the sample is classified into six regions (FIG. 27), reflecting local heterogeneity, likely caused by variations in thickness, surface termination, or defects. The green and blue regions correspond to few-layer areas of varying thickness, while the yellow, purple, and dark blue regions represent bulk areas. This segmentation highlights subtle differences across both few-layer and bulk regions, capturing local structural and electronic variations that influence the material's overall properties. Additionally, distinct types of edges are observed, one associated with the bulk region and another with the few-layer region, indicating sharp transitions in material properties at these boundaries.

Closer examination reveals that the purple cluster extends significantly along the PC1 and PC2 axes, despite its similarity to the yellow region in the bright-field image. However, its distinct distribution in PCA coordinates demonstrates notably different electronic and vibrational dynamics. The score vector for this cluster predominantly reflects contributions from slow decay characteristics and phononic activity, with a stronger presence of these features indicating enhanced phonon-electron coupling. This coupling likely facilitates more efficient energy transfer and extends carrier lifetimes in these localized regions. These findings suggest that exfoliation introduces a more complex internal structure or surface effects than may be anticipated. By effectively differentiating these regions within PCA space, PRISM reveals diverse inter-and intramolecular interactions even in visually homogeneous areas. This highlights PRISM's ability to capture and correlate fine-scale variations, making it a valuable tool for probing intricate spatial and dynamic heterogeneities within materials.

In summary, the use of WSe₂ and perovskite microcrystals demonstrates PRISM's capability to resolve structural heterogeneity and correlate electronic and vibrational dynamics. By enabling simultaneous mapping of carrier and lattice behaviors across large areas, PRISM offers potential for studying electron-phonon coupling in a variety of materials, extending beyond the examples in this work. Its wide-field, non-scanning approach, combined with fast acquisition speeds, addresses the limitations of traditional point-by-point methods, allowing for spatial-temporal-spectral correlation and integration with both imaging and non-imaging techniques. This flexibility makes PRISM suitable for monitoring both static and dynamic processes in various physical, chemical, and biological contexts.

The PRISM setup in these examples is as follows. In the wide-field imaging measurement, the pump and probe beams are generated by a second harmonic and a third harmonic noncolinear optical parametric amplifier (such as that from Light Conversion Ltd.), respectively. Both beams feature a repetition rate of 200 kHz and pulse duration of 30 fs. The pump beam has an adjustable wavelength range of 680 nm to 900 nm, while the probe beam's range is tunable from 530 nm to 730 nm. The pump and probe beams are softly focused by the curved mirror to the sample plane with a FOV of 80×80 μm². The delay time between the pump and probe is adjusted using the voice coil stage (such as that from Physik Instrumente), positioned in the probe path and moving sinusoidally at 10 Hz. An 50×/0.42 NA objective collected the transmitted probe light through the sample, forming the wide-field image through the tube lens and subsequently captured by the high-speed camera at a frame rate of 20,000 FPS and readout by the frame grabber (such as that from Euresys) while the stage was in motion. The camera features a resolution of 256×320 pixels and with the FOV tailored to 57.5×46 μm.

The real-time position of the stage is monitored using an interferometric method. The beam emitted from the Helium-Neon (HeNe) laser is split into two paths, with one passing through the voice coil stage and the other being reflected by the fixed mirror. The interference pattern, resulting from the combination of the two reflected beams, is detected by the photodiode (such as that from Thorlabs) and recorded by a high-speed digitizer. The laser, camera and digitizer are synchronized to the same electronic pulse train generated by a counter output module (such as that from National Instruments). In addition, bright-field and photoluminescence images are acquired using the integrated CMOS camera (such as that from Thorlabs) within the PRISM system, synchronized with all the hardware. A single image is captured at the start of each scan.

The sample preparation is as follows for these examples. The WSe₂ is prepared through mechanical exfoliation using Scotch brand tape. Thin layers of WSe₂ are lifted from a bulk crystal and transferred onto a clean glass substrate by pressing the tape onto the surface and gently peeling it away, leaving behind exfoliated flakes. The MAPbBr₃ and MAPb(BrₓI₋ₓ)₃ mixed halide microcrystals are synthesized with a spontaneous solvent evaporation method. Furthermore, precursor solutions for MAPbBr₃ and MAPbl₃ are prepared by dissolving equimolar amounts of MABr and PbBr₂ in Dimethylformamide at room temperature, followed by stirring the mixture at 1000 rpm for 2 hours to ensure complete dissolution. Similarly, MAI and Pbl2 are dissolved in Gamma-Butyrolactone (GBL) to form the MAPbl₃ precursor solution. The mixed halide microcrystals of MAPb(BrₓI₋ₓ)₃ are obtained by mixing the MAPbBr₃ and MAPbl₃ precursor solutions in a 10:3 ratio. For crystallization, the precursor solution is further mixed with GBL in a 1:1 ratio to produce a saturated solution. A microdroplet (˜1 μL) of the supernatant is then placed on a cover glass, and upon natural solvent evaporation, microcrystals began to form within minutes.

Another feature of the present apparatus and method provide beneficial replacement of a conventional Atomic Force Microscope. There is a direct relationship between the layer number of specimen materials and their optical response. This is because: (a) the intermolecular forces between layers control the frequency and dephasing times of the phonons in these materials; and (b) in many materials the electronic structure is sensitive to the layer number through Coulombic interactions. However, the strength of the relationship depends strongly on the specific material. This means that when the optical response is measured, information about the material topography can be recovered using machine learning, such as with an artificial intelligence, evolutionary learning algorithm.

Moreover, the frequency maps can be used to reveal hidden grain boundaries and strain in the sample material. These features are very difficult to observe with most traditional methods and they often require scanning electron microscopy, AFM, or other atomic resolution methods. Here, with the present system and method, these features can be observed optically and in-situ.

Measuring AFM and PRISM on the same sample provides thousands of data points to correlate the two measurements. Therefore, the programmable controller using machine learning is able to predict one based on measurement of the other. Hence, when the PRISM signal is measured, the same information as AFM can be recovered. The present PRISM configuration provides an all-optical remote AFM-like measurement, but with notable advantages over AFM:
No contact with the sample using PRISM since it can be done remotely from 1 mm to 10 meters away from the microscope.
PRISM may be used on buried interfaces (e.g., when there is a layer on top of the material or some other obstacle to direct contact with the AFM tip).
PRISM can be done in a wide field modality, as compared to AFM which requires scanning the tip across the sample which is very slow (tens of seconds to minutes, typically). Here, AFM-like data obtained with PRISM comes from across the entire sample area at once. This also allows observation of processes that change rapidly with time.
PRISM is not subject to interference from background materials/debris/contaminants that can make direct AFM very challenging.

### Machine Learning Using Optical Spectroscopic Data

An optional machine learning aspect of the present PRISM system and method is now discussed as a chemical space-property predictor model of perovskite materials, by way of nonlimiting example, by high-throughput synthesis and artificial neural networks. Lead halide perovskites are a promising class of materials with applications in photovoltaic and optoelectronics. These materials exhibit highly tunable optical properties owing to their soft lattice structure. In the present example, a library of lead halide perovskite single crystals is synthesized using high-throughput liquid handling robotics and characterized by optical spectroscopy to train a multi-output artificial neural networks (“ANN”) based chemical space-property predictor model. The model accurately predicts the chemical compositions of elements in lead halide perovskite materials directly from optical spectroscopic data.

The lead halide perovskites have a general formula, MAₓCs_{1-xP}b(ClₓBr_{y}I_{1-x-y})₃ where x and y vary from 0 to 1, thereby incorporating all combinations of mono-halide, di-halide, and tri-halide perovskite single crystals. UV-visible, photoluminescence, and THz Raman spectroscopic data sets are acquired on all 66 perovskite single crystals and used as predictors for chemical composition in the ANN models. A Levenberg-Marquardt based ANN algorithm using only THz Raman spectroscopic data (2 cm⁻¹ to 200 cm⁻¹) shows 85% accuracy in predicting chemical composition. The incorporation of UV-visible spectroscopic data with THz Raman spectroscopic data boosts the accuracy of the model to more than 92%. However, the adverse impact of phase segregation in mixed halide perovskites greatly limits the use of PL data in training the model. The present system and method allow for real-time monitoring and defect detection, degradation analysis, and streamlined material selection and optimization of perovskite materials in industrial production.

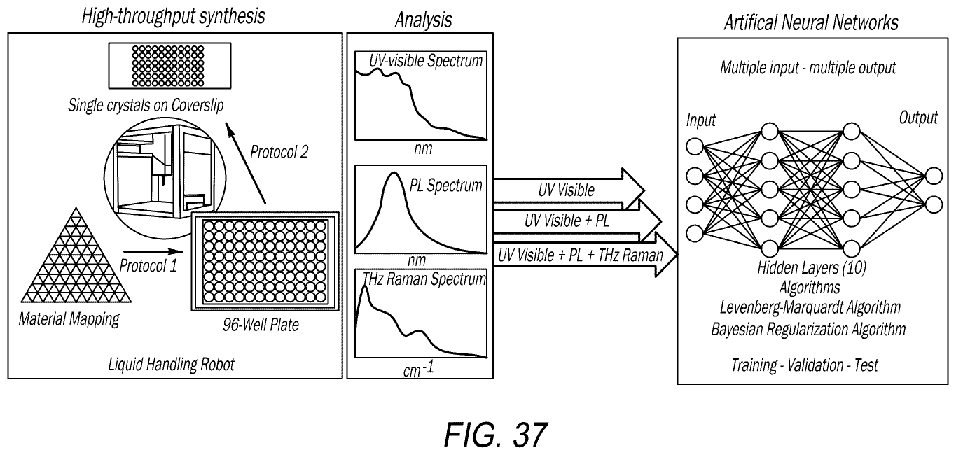

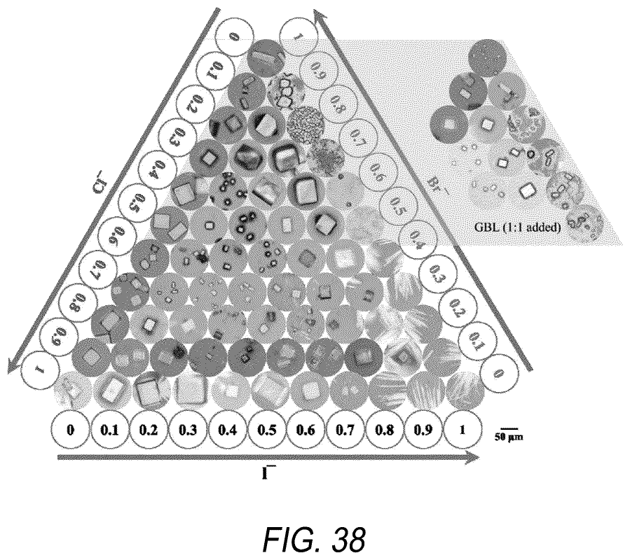

FIG. 37 shows the chemical space-property predictor model development workflow. On the left side of the figure, high-throughput approaches are used for the synthesis of an array of perovskite single crystals, in the middle, spectroscopic analysis of the perovskites, and data accumulation for artificial neural networks model is shown, and on the right side, data flows to ANN in order to develop the desired model.

The present methodology integrates high-throughput (“HT”) synthesis techniques with artificial neural networks to generate a predictive chemical space property descriptor model. The use of an HT approach provides a procedure to efficiently explore the large chemical and physical space of lead halide perovskites. This HT approach incorporates automated robotized synthesis, characterization and data acquisition. Moreover, HT synthesis enables the rapid synthesis and screening of large libraries of perovskite samples, providing a robust and reproducible set of experimental data. When the HT approach is coupled with machine learning (“ML”) in the present method, the data can be utilized to develop predictive models that can accurately predict the properties of perovskites based on their chemical composition. Such models can significantly explore the correlations among the vast chemical space and specific properties for specific applications. The present ML model employs ANN, which includes multiple hidden layers capable of processing multiple predictor and response variables simultaneously.

The HT synthetic approach generates training data for an ANN to develop a model that can accurately predict the chemical compositions of unseen perovskite materials based solely on optical spectroscopic data. A large array of perovskite materials and their single crystals is synthesized using an HT approach facilitated by a liquid handling robot under uniform experimental conditions. The array comprises mono-halide, di-halide, and tri-halide perovskites, covering all possible combinations of halides. The samples are analyzed spectroscopically, and the spectroscopic data is used as predictor variables in an ANN to develop a model that can predict the chemical composition of each element in the perovskite materials with high accuracy.

First, robot-assisted high-throughput synthesis workflow is considered. As can be observed in FIG. 38, the perovskite materials are represented by a ternary plot having eleven grids on one of three axes, which represent the chemical compositions of chloride, bromide, and iodide. Each cross-section point of grids on the ternary plot represents a perovskite material with the chemical composition of halides at that point of intersection. The mapping of materials in this way covers all the mono-halide, di-halide, and tri-halide perovskites.

Robot-assisted HT synthesis is incorporated to synthesize perovskite single crystals with high accuracy, precision, and reproducibility. An Opentrons OT-2 liquid handling robot, by way of nonlimiting example, along with a heater-shaker module (such as GEN1) is used to synthesize these materials from precursor solutions. The high-throughput synthesis workflow is divided into two parts. First, the mixing of the precursor solutions in specific ratios to prepare the desired perovskite materials on a 96-well plate, and second, growing microdroplets of perovskite single crystals deposited on a coverslip.

Three precursor solutions (MAPbCl₃, CsPbBr₃, and CsPbl₃) of the same concentration (0.133 M) are used. The liquid handling robot automatically mixes the precursor solutions in different stoichiometric ratios to synthesize the desired perovskites. The robot executes the job using two working protocols. Following protocol 1, the robot takes a predefined volume of precursor and dropped the solution into a specific well of the well plate. Then, it adds the specified volume of other precursors to the well. The heater-shaker established homogeneous mixing of the solutions.

Immediately after completing Protocol 1 for all the perovskite materials, absorption spectra are automatically recorded for each sample in the well plate using a microplate reader (such as SPECTROstar). Protocol 2 maps these materials as droplets and subsequently as single crystals on a coverslip. This protocol uses a tip and a lab-designed well plate to place a tiny droplet (˜50 nL) of solution on a coverslip affixed to an aluminum block. In some cases, for the convenience of optical measurements, different perovskite single crystals are grown on different coverslips. Mixture solutions in the well plate and single crystals on coverslips are then used for further optical analysis.

Crystallization and effects of solvent on crystal size and shape are considered. All the perovskites are crystalized under the same ambient conditions. Dimethyl sulfoxide (DMSO) solvent has higher solubility and stronger coordination than the N, N-Dimethylformamide (DMF), or y-Butyrolactone (GBL) solvents. The DMSO solvent increases the crystallization time, resulting in larger crystals. DMF, on the other hand, is more volatile and reduces the crystallization time, thereby making the crystals comparatively smaller. The materials easily separate from the GBL solvent because of its low solubility and weak coordination. Also, the GBL solvent improves the size and shape of lead-bromide perovskite single crystals. FIG. 38 shows representative single crystals of all perovskites synthesized under the same crystallization conditions. The single crystals of CsPbBr₃ and MAPbCl₃ are mostly cubic, while CsPbl₃ are rod-shaped.

The precursor solutions are prepared using DMF, DMSO, and GBL. Here, the single crystals form under the influence of these solvents, and the solvent ratio changes from one mixture to another. The single crystals of the iodide rich region are predominantly rod shaped and that of chloride and bromide rich regions are predominantly cubic shaped. The crystals in the central region are primarily smaller and exhibit a cubic shape and this region is comprised of tri-halide perovskites. The bromide rich crystals at the right top part of the figure are relatively larger. These perovskites are crystallized using 1:1 GBL solvent as the GBL improves the crystals of bromide-containing perovskites. To the right of the figure, the GBL-assisted crystals are displayed, whereby nearly all crystals have become smaller in size and cubic in shape.

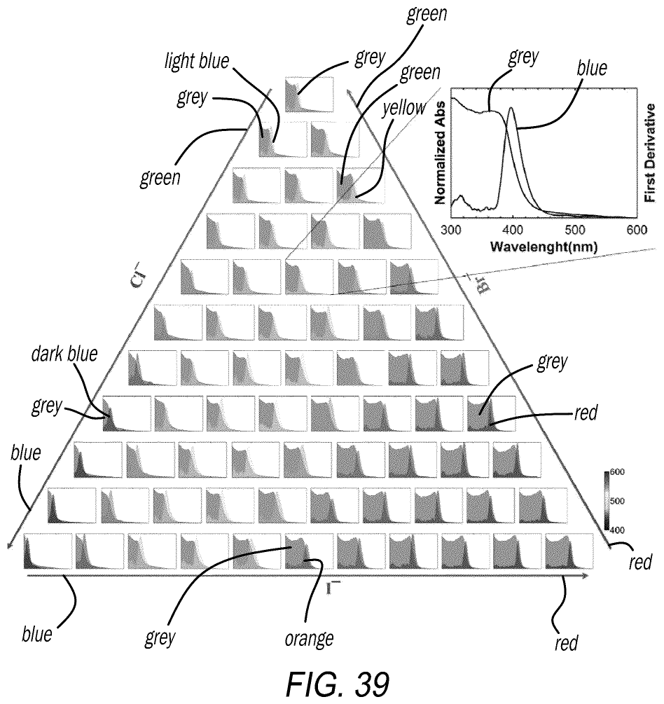

The UV-visible spectra of the perovskite samples are next examined. The array of perovskites synthesized represent a continuous change in the chemical composition of cations and halides that impose a subsequent continuous change in the band structure. The absorption spectra of the perovskites changed from blue region (˜400 nm) to green region (˜500 nm) to red region (˜700 nm) of the electromagnetic spectrum as the halide composition changed from chloride to bromide to iodide. FIG. 39 displays the absorption spectra of all perovskite samples recorded directly under the microplate reader without any additional treatment or modification. The first derivative of the spectrum is also presented with the spectrum in the figure using a colormap to visualize the change of spectrum with chemical composition.

The pure chloride-containing perovskites absorbed light in the blue region (˜400 nm), while the pure iodide-containing perovskites absorbed in the red region (˜700 nm) of the electromagnetic spectrum. The pure bromide-containing perovskite fell in between these two extremes (˜500 nm). For mixed halide perovskites, the spectral peak position depended on the presence and predominance of one halide over the other in the Pb-X frameworks. In trihalide perovskites, where the presence and position of spectral peak is influenced by all three halides, the tunability range is broad.

The electronic environment is also sensitive to the cation that takes its position in the interstice of the corner-sharing octahedra. As a result, the bandgap shifts depending on the type and composition of the cations, especially in cases where multiple cations are present in the mixture. A gradual shift in peak positions is observed as both the cation and halide chemical compositions changed, indicating a correlation between peak position and chemical composition. Therefore, the absorption spectral data is expected to have some ability to predict the chemical composition of an unknown perovskite sample using the ANN model.

FIG. 39 shows the UV-visible spectra and their first derivative curve of perovskite materials. The UV-visible spectra are represented by gray color and the first derivative curves are represented by colormap with 50% appearance. Also, the color of the first derivative curve was selected from colormap based on the wavelength of peak maxima. The spectra are positioned following the coordinate system of the ternary plot.

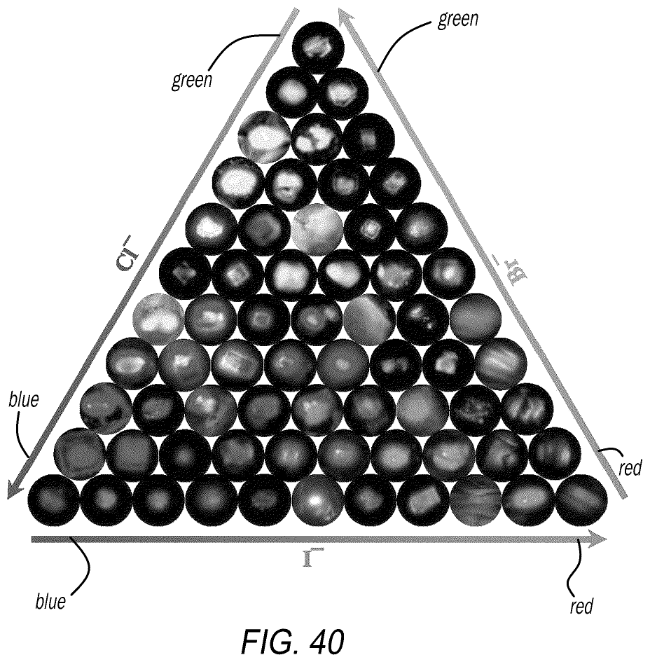

The PL image and spectrum of the perovskite single crystals is recorded simultaneously upon exciting the crystal with a 343 nm laser. FIG. 40 shows PL images and PL spectra of the perovskite materials. Like the absorption spectra, the PL image and spectra of perovskites are also influenced by the halide type and composition. Furthermore, the cation composition also affects the peak position. The PL images shifted color from blue to green to red as the halide changed from chloride to bromide to iodide in the perovskite structure. The PL spectrum also followed the same order.

When comparable amounts of halides are present the color of PL image becomes distinct from that of the pure samples, and the intensity of color also changes with the composition of halide in the crystal. Some of the crystals show colors near the edge distinct from the bulk which might be due to the segregation of halides in the bulk and edge region. The perovskites containing iodide with one other halide show two distinct peaks in the PL spectrum and with irradiation time the intensity of the peak in the red region increases while that at the blue region decreases. The perovskites with a chloride-bromide mixture exhibit a gradual shift in peak position from blue to green in the PL spectrum as the bromide composition increased, and vice versa.

In some single crystals of tri-halide perovskites, three distinct peaks appear that correspond to three halides and the intensity readily shifts from the peak of the blue region to the peak of the red region. Note, the PL intensity and peak position of a perovskite with a certain chemical composition, changes with irradiation time in mixed halide perovskites. Among the 66 perovskites in this example, 63 are mixed-halide perovskites. The evolution of the emission occurs because the energy absorbed by the carrier of the bromide-rich center transfers to the iodide-rich carriers, with the electron transfer from the conduction band of bromide to that of iodide via intersystem crossing.

FIG. 40 depicts photoluminescence images of perovskite single crystals, where the excitation source is a 343 nm laser. The images are represented following the coordinate system of the ternary plot.

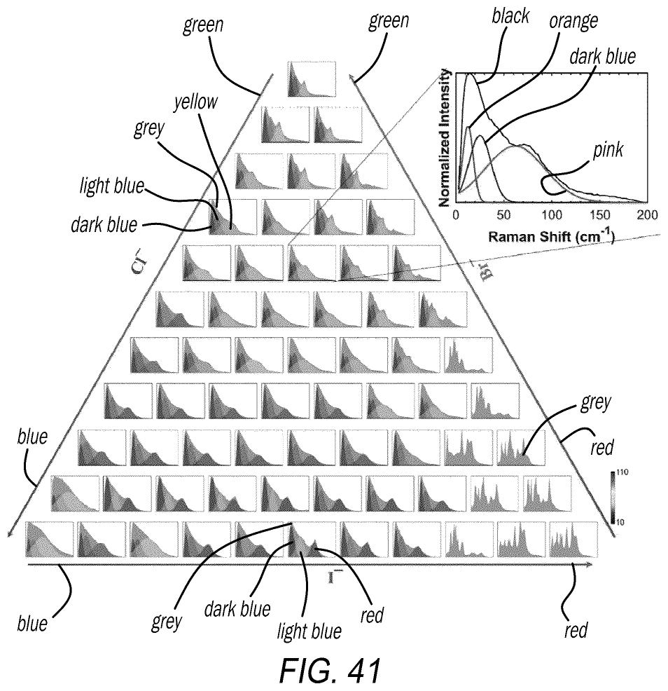

THz Raman spectra are recorded in the THz region from 0.06 THz to 6 THz (2 cm⁻¹ to 200 cm⁻¹) using a Raman microscope with a 785 nm laser. FIG. 41 shows the Stokes Raman scattering of all the samples recorded in the same ambient condition in the THz Raman microscope. To better visualize spectral changes in the THz Raman data, the spectra are fitted to a sum of three gaussian functions, represented by distinct colors according to their center frequencies. THz Raman spectroscopy can detect subtle changes in the lattice deformation and lattice vibrational motion that indicate phase transitions, such as from cubic to tetragonal or orthorhombic phases, which are common in perovskites. The method is capable of probing low-frequency vibrational modes such as breathing modes, and shear modes which provide insights into the stiffness, stability, and dynamic behavior of the perovskite lattice.

The Raman scattering for the symmetric stretching mode of the Pb-X bond, the anti-symmetric stretching mode of the Pb-X bond, and the bending mode of the Pb-X-Pb bonds appear in this region. As the halide and halide composition changes, the bond strength changes, which is reflected in the Raman scattering frequency. In general, the bending mode corresponds to lower energy vibration and the Raman scattering of the mode appears at a lower Raman shift value (<40 cm⁻¹) than that of the symmetric stretching mode. The anti-symmetric stretching mode gives rise to Raman scattering at the highest value (>70 cm⁻¹) among these three modes.

In all of the samples, the first peak at low frequency is for the bending mode of Pb-X-Pb bonds and its position changed due to the change of halide composition in the Pb-X framework. In the bottom row of the figure, where iodide content is increasing from left to right in the framework, a peak appears near 100 cm⁻¹ corresponding to the anti-symmetric mode of the Pb-X bond and shifts to the high-frequency region with an increase of iodide content in the framework. This mode shifts to a lower value as iodide is replaced by bromide (along the bromide line). In mixed halide perovskites, the contribution to the spectra arises from different Pb-X type bonds.

The single crystals with high iodide content (<0.7) exhibit different THz Raman spectra compared to crystals with lower iodide content. The spectra of these high iodide-content crystals showed some resemblance to that of the Pbl₂ precursor. This is likely due to perovskite crystals coprecipitating with some precursor crystals which contributed to different features in the Raman spectra. This phenomenon is not revealed in traditional electronic absorption and emission spectroscopic data. The distinctiveness of THz Raman spectroscopic data across various perovskite samples underscores its potential for developing a predictive model for chemical composition.

FIG. 41 depicts THz Raman spectra of perovskite single crystals which are represented by gray color and the deconvoluted peaks are represented by colormap with 50% appearance. The color of the peaks was selected from colormap based on the wavenumber of peak maxima. The spectra are positioned following the coordinate system of the ternary plot. Raman laser source is a 785 nm laser.

A more detailed discussion of the present Artificial Neural Networks is as follows. The present system and method advantageously use an ANN model that can predict multiple variables by designing the architecture with multiple hidden layers and multiple output neurons. The input layer receives the input features, and these features are processed through the network. Multiple hidden layers are used to learn complex representations and patterns in the data.

The output layer contains multiple neurons, one for each target variable, with the number of neurons corresponding to the number of variables being predicted. During training, the weights of the network are automatically (or less preferably, manually) adjusted iteratively to minimize the combined loss function, which accounts for errors in predicting each target variable. This process continues until the network converges or reaches a specified number of epochs. The networks handle dependencies between multiple outputs through shared hidden layers. These layers learn representations that are useful for predicting all target variables, capturing any correlations between them. Accordingly, this approach leverages the power of ANN to model complex and interdependent relationships in the data, making them well-suited for multi-output prediction tasks.

The ANN has been employed here to construct a model capable of predicting the chemical composition of perovskite materials. Five different data sets (UV-visible data, PL data, THz Raman data, UV-visible and THz Raman data, and UV-visible, PL and THz Raman data) are used as predictors and the compositional values, x and y, of the samples are used as responses. The models with these five data sets are constructed using Levenberg-Marquardt and Bayesian Regularization algorithms. The Levenberg-Marquardt algorithm randomly splits these data into three subsets: training (70% data), validation (15% data), and test (15% data). The Bayesian Regularization algorithm randomly splits the data into training (85% data) and test (15% data) subsets.

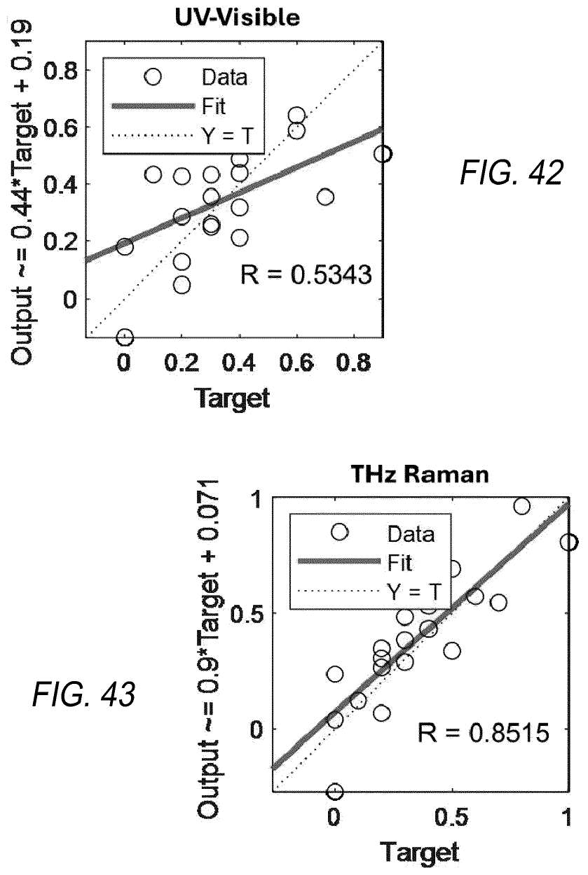

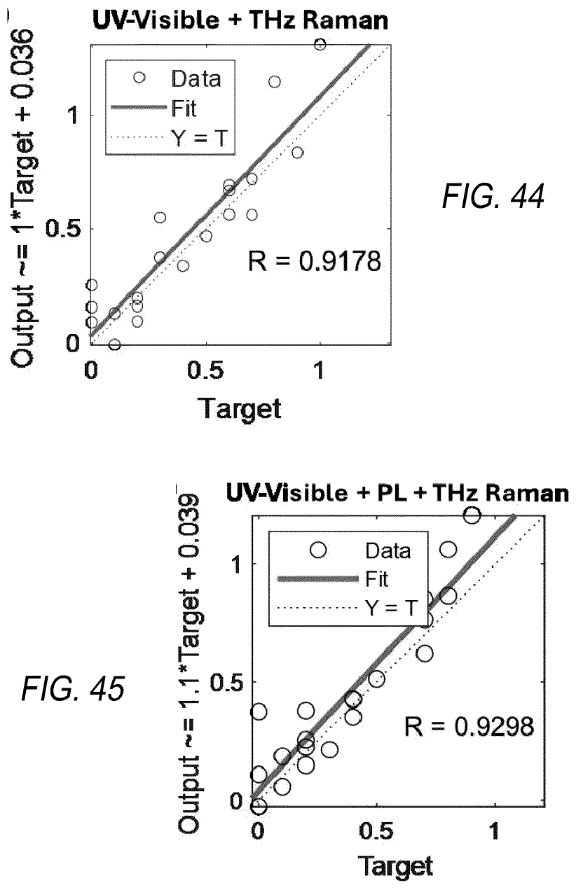

The training data is used to train the model. During training, the model iteratively adjusts its parameters (weights and biases) to minimize errors between its predictions and the labels. This process involves forward propagation, where the model makes predictions, and backpropagation, where errors are calculated and used to update the model's parameters. After each training epoch, the model is evaluated on the validation dataset. This evaluation helps monitor the model's performance on unseen data, which is crucial for detecting overfitting and tuning hyperparameters, such as learning rate, batch size, number of layers, and dropout rates based on validation performance. After the model has been trained and validated, it is evaluated on the testing dataset. The testing data provides an unbiased evaluation of the model's performance on completely unseen data. The statistical results (regression coefficient and mean squared error) of these algorithms using different data sets are presented in FIGS. 42-45. Across all models, the Levenberg-Marquardt algorithm consistently constructs models with higher accuracy in a shorter timeframe compared to the Bayesian Regularization algorithm.

In most instances, the Bayesian Regularization algorithm yields a model with comparatively lower accuracy in prediction, as evidenced by the examination and comparison of regression coefficients and mean squared errors. The UV-visible data produces a better model compared to the PL data, exhibiting a regression coefficient of 0.534. The model with THz Raman data outperforms that of UV-visible data, with the regression coefficient notably increasing to 0.851. Among these three data sets, the THz Raman data have the highest predictability of the chemical composition of the elements of perovskite materials.

The subsequent model is generated using a dataset that incorporates both UV-visible and THz Raman data. This dataset results in a regression coefficient value of 0.917, giving the highest level of accuracy and predictability regarding chemical compositions of all the models tested. This is further confirmed by analyzing the mean squared error (“MSE”) and regression coefficient of both the training and validation data subsets across all the models tested.

The feature importance analysis in ANN is helpful for improving model interpretability, allowing the user to discern which features drive predictions. This analysis can be conducted through various methods, including examining the weights and using permutation feature importance. The features importance analysis depends on the weights and biases of the network, as they directly affect how input features influence the output. Additionally, the network architecture, choice of activation functions, and training parameters are notable factors that shape feature importance.

Permutation feature importance yields more insightful results compared to weights analysis. According to the permutation feature analysis, for the UV-visible spectroscopic data, features within the 305-315 nm, 370-470 nm, and 540-600 nm regions significantly influence the model and its predictive accuracy. For THz spectroscopic analysis, features in the 10-19 cm⁻¹ (Pb-X bending mode), 40-60 cm⁻¹ (X-Pb-Br sym. stretching mode), and 120-185 cm⁻¹ (X-Pb-X asym. stretching mode) ranges are particularly impactful.

In conclusion, the ANN based predictor model accurately predicts the chemical compositions of perovskite materials solely from optical spectroscopic data. This approach may accelerate the industrial production of perovskite and/or other materials by rapidly validating chemical composition of materials and identifying specific features. It may also enhance quality control by ensuring consistency in production and enabling real-time adjustments during production. Additionally, this will also expedite the development of next-generation perovskite materials and will reduce the gap between synthesis and application.

While various embodiments have been disclosed, it should be appreciated that additional variations of the present apparatus and method are also envisioned. For example, while exemplary expected results have been disclosed, the actual results may vary. Moreover, additional or different hardware components may be used although certain of the present advantages may not be fully realized. While certain types of optical, laser and camera components have been disclosed it should be appreciated that alternate components may be used although all of the present advantages may not be fully achieved (for example, other gratings, lenses and mirrors). While a single programmable controller has been disclosed, the functions and software instructions discussed herein may be alternately divided between multiple computers and/or remote cloud processors. It is also noteworthy that any of the preceding features may be interchanged and intermixed with any of the others. Accordingly, any and/or all of the dependent claims may depend from all of their preceding claims and may be combined together in any combination. Variations are not to be regarded as a departure from the present disclosure, and all such modifications are entitled to be included within the scope and sprit of the present invention.

The invention claimed is:

1. A method of using a spectroscopic mapping system, the method comprising:
(a) emitting light from a probe laser at the sample;
(b) emitting light from a pump laser at the sample;
(c) magnifying images of the sample with a microscope;
(d) capturing at least 100,000 sensed image data points from each of the images of the sample in less than or equal to 50 milliseconds, and capturing at least 20,000 frames per second, with a high-speed camera; and
(e) time synchronizing the probe laser, the pump laser and the high-speed camera.

2. The method of claim 1, further comprising using machine learning software, stored in non-transient memory and run by a programmable controller, to automatically detect otherwise hidden molecular correlations or patterns in the sample.

3. The method of claim 2, wherein the machine learning software comprises calculating a Levenberg-Marquardt based artificial neural network algorithm using Raman spectroscopic data obtained from the captured images.

4. The method of claim 2, further comprising using a high throughput liquid handling robot with artificial neural network software to at least one of: (a) generate a predictive chemical space property descriptor model regarding the sample; (b) obtain automated robotized synthesis, characterization and data acquisition regarding the sample; or (c) automatically screen large libraries of data from multiples of the sample from the captured images thereof.

5. The method of claim 1, further comprising parallel mapping of vibrational motions and excited-state dynamics with a programmable controller coupled to the high-speed camera.

6. The method of claim 1, further comprising high-resolution mapping of electronic and vibrational states over a large field of view, and a programmable controller automatically optically disentangling local effects caused by sample morphology through correlation analysis to enable identification of hidden spatial domains.

7. The method of claim 1, further comprising emitting light from a tracer laser to detect a spatial position of a voice coil, which performs the synchronizing, at a moment the high-speed camera captures the image data points.

8. The method of claim 1, further comprising viewing living cell activity in real-time with the captured images.

9. The method of claim 1, further comprising conducting medical imaging in real-time with the captured images.

10. The method of claim 1, wherein the high-speed camera captures at least 1.6 million spectra data points per second of the sample, with each spectra containing at least 200 points, to obtain at least 400 nm high-resolution of the captured images without raster scanning.

11. The method of claim 1, further comprising operating a voice coil synchronizer at at least 10 Hz and capturing a hyperspectral data cube at no more than 20 Hz, to obtain both fast dynamics of the sample and slower dynamics of the sample in the captured images.

12. The method of claim 1, further comprising providing a full vibrational range of frequencies at the same time to the sample with the laser lights, which allows a programmable controller to automatically distinguish at least one of: between different material characteristics or different intermolecular interactions, in the sample.

13. The method of claim 1, further comprising:
automatically denoising data obtained from the captured images by using a global fitting algorithm which fits an entire signal to a sum of exponentially decaying sinusoidal functions;
subtracting a low-frequency part of the fit from a denoised signal to reveal decay terms at each pixel and a vibrational frequency at each pixel; and
thereafter subjecting a residual to a singular value decomposition to further reduce noise terms contained in higher singular values.

14. A method of using a spectroscopic mapping system, the method comprising:
(a) emitting light from a probe laser at the sample;
(b) emitting light from a pump laser at the sample;
(c) magnifying an image of the sample with a microscope;
(d) capturing images of the sample with a camera;
(e) time synchronizing the probe laser, the pump laser and the camera with a voice coil actuator; and
(f) parallel mapping of vibrational motions and excited-state dynamics from the images with a programmable controller coupled to the camera.

15. The method of claim 14, further comprising using machine learning software, stored in non-transient memory and run by a programmable controller, to automatically determine characteristics of the sample.

16. The method of claim 14, further comprising mapping of vibrational motions and excited-state dynamics with a programmable controller coupled to the camera.

17. The method of claim 14, further comprising emitting light from a tracer laser to detect a spatial position of the voice coil at a moment the camera captures the image data points.

18. The method of claim 14, further comprising viewing living cell activity in real-time with the captured images, including at least one of: (a) cell division; or (b) cell interaction with a pharmaceutical composition.

19. The method of claim 14, further comprising viewing crystal growth in real-time with the captured images.

20. The method of claim 14, wherein the camera captures at least 1.6 million spectra data points per second of the sample, with each spectra containing at least 200 points, to obtain at least 400 nm high-resolution of the captured images.

21. The method of claim 14, further comprising:
automatically denoising data obtained from the captured images by using a global fitting algorithm which fits an entire signal to a sum of exponentially decaying sinusoidal functions;
subtracting a low-frequency part of the fit from a denoised signal to reveal decay terms at each pixel and a vibrational frequency at each pixel; and
thereafter subjecting a residual to a singular value decomposition to further reduce noise terms contained in higher singular values.

22. Software used in a spectroscopic mapping system, the software being stored in non-transient memory and run by a controller, the software comprising:
(a) instructions causing an emission of a laser pulse at a sample;
(b) instructions receiving at least 1.6 million per second sensed and magnified spectra data points captured from the sample, as a function of both time delay and amplitude modulation;
(c) instructions averaging the spectra data points over multiple cycles to improve a signal-to-noise ratio therein;
(d) instructions using machine learning calculations to cluster pixels according to similar properties; and
(e) instructions generating a hyperspectral map grouping pixels according to their microscopic properties.

23. The software of claim 22, wherein the instructions using machine learning calculations further comprises calculating a Levenberg-Marquardt based artificial neural network algorithm using Raman spectroscopic data obtained from the captured images.

24. The software of claim 22, further comprising instructions using an artificial neural network to at least one of: (a) generate a predictive chemical space property descriptor model regarding the sample; (b) obtain automated robotized synthesis, characterization and data acquisition regarding the sample; or (c) automatically screen large libraries of data from multiples of the sample from the captured images thereof.

25. The software of claim 22, further comprising instructions parallel mapping of vibrational motions and excited-state dynamics with a programmable controller coupled to a high-speed camera.

26. The software of claim 22, further comprising instructions creating high-resolution mapping of electronic and vibrational states over a large field of view, and automatically optically disentangling local effects caused by sample morphology through correlation analysis to enable identification of hidden spatial domains.

27. The software of claim 22, further comprising denoising instructions:
automatically denoising data obtained from the captured images by using a global fitting algorithm which fits an entire signal to a sum of exponentially decaying sinusoidal functions;
subtracting a low-frequency part of the fit from a denoised signal to reveal decay terms at each pixel and a vibrational frequency at each pixel; and
thereafter subjecting a residual to a singular value decomposition to further reduce noise terms contained in higher singular values.

28. A spectroscopic mapping apparatus comprising:
(a) a probe laser configured to send probe laser pulses at a specimen;
(b) a pump laser configured to send probe laser pulses at a specimen;
(c) a high-speed camera configured to obtain images of the specimen;
(d) a microscope located between the lasers and the high-speed camera;
(e) a voice coil configured to synchronize timing of the lasers and camera;
(f) a tracer laser configured to send light to detect a spatial position of the voice coil; and
(g) a programmable controller configured to:
(i) automatically denoise output data obtained from the images;
(ii) automatically create a digital map of the specimen in real-time based on output data obtained from the images; and
(iii) automatically create at least one of: (a) a predictive chemical space property descriptor model regarding the specimen; (b) automated robotized data characterization regarding the specimen; or (c) screen large libraries of data from multiples of the specimen from the captured images thereof.
